(19) United States
(12) Patent Application Publication
(10) Pub. No.: US 2024/0000086 A1
(43) Pub. Date: Jan. 4, 2024

(54) PHAGE-BASED PESTICIDE AGAINST VARROA DESTRUCTOR

(71) Applicant: BEEKEEPING 101, LLC, MANSFIELD, OH (US)

(72) Inventors: Julianne H. Grose, Provo, UT (US); Gerald W. Hayes, Jr., Mansfield, OH (US)

(21) Appl. No.: 18/040,742

(22) PCT Filed: Aug. 11, 2021
(86) PCT No.: PCT/US2021/045591

§ 371 Date: Feb. 6, 2023

Related U.S. Application Data
(60) Provisional application No. 63/085,782, filed on Sep. 30, 2020.
(60) Provisional application No. 63/064,282, filed on Aug. 11, 2020.

(51) Int. Cl. A01N 63/40; A01P 7/00; A01P 1/00

(52) U.S. Cl. CPC A01N 63/40; A01P 7/00; A01P 1/00

(57) ABSTRACT

Compositions and methods for use in preserving a beehive or bees associated with the beehive against Varroa destructor infestation-induced collapse or death, or supporting the health, vitality, and longevity of a beehive or bees associated with the beehive by controlling, reducing, or eliminating a population of Varroa destructor associated with the beehive or bees associated with the beehive through targeted, phage-based, bactericidal or bacteriostatic activity against Bacillus sp., Hafnia sp., and/or Escherichia sp. present in Varroa destructor associated with the beehive or bees associated with the beehive, and specifically by applying or administering to the beehive, or to bees associated with the beehive, a composition comprising one or more bacteriophage having cellular tropism for, or infectivity specific for, Bacillus sp., Hafnia sp., and/or Escherichia sp. in Varroa destructor associated with the beehive or bees associated with the beehive.

### CROSS-REFERENCE TO RELATED APPLICATIONS

This application claims priority to and the benefit of: (i) U.S. Provisional Patent Application Ser. No. 63/064,282, filed Aug. 11, 2020, and titled “A Phage-based Therapy for Varroa Destructor Mite,” and (ii) U.S. Provisional Patent Application Ser. No. 63/085,782, filed Sep. 30, 2020, and titled “Phage-based Therapy for Varroa Destructor Mite,” the entirety of each of which is incorporated herein by specific reference.

### TECHNICAL FIELD

### Technical Field

The present disclosure relates to killing or sickening Varroa destructor associated with a beehive or honey bee colony, and particularly to compositions and methods for use in preserving a beehive or bees associated with the beehive against Varroa destructor infestation-induced collapse or death, or supporting the health, vitality, and longevity of a beehive or bees associated with the beehive by controlling, reducing, or eliminating a population of Varroa destructor associated with the beehive or bees associated with the beehive through targeted, phage-based, bactericidal or bacteriostatic activity against Bacillus sp. (e.g., Bacillus paralicheniformis), Hafnia sp. (e.g., Hafnia paralvei), and/or Escherichia sp. (e.g., Escherichia coli) present in, internal to, and/or associated with Varroa destructor that is/are associated with the beehive or with bees associated with the beehive, and specifically to compositions comprising one or more bacteriophage having cellular tropism for, or infectivity specific for Bacillus sp. (e.g., Bacillus paralicheniformis), Hafnia sp. (e.g., Hafnia paralvei), and/or Escherichia sp. (e.g., Escherichia coli) in, internal to, and/or associated with Varroa destructor that is associated with the beehive or with bees associated with the beehive, and methods of manufacturing and using the same.

### Background

More food is desperately needed for our growing world. As farms expand they contribute to climate change through the increased use of land, water, chemical treatments, and agricultural machinery, affecting crop production itself in a vicious cycle. To end this vicious cycle, advancements to minimize crop loss and maximize production are desperately needed. A key advancement in the United States (U.S.) has been the use of the Western Honey Bee (Apis mellifera) for increased pollination, contributing nearly billions to the value of U.S. crop production alone and greater than 9% to crop production across the world. In the past 15 years, dramatic honey bee losses during overwintering have been reported in the U.S. and Europe, threatening crop production.

Most honey bee experts cite Varroa destructor (the Varroa mite) as the greatest contributor to and cause of honey bee decline and of beehive colony collapse. The Varroa mite is an obligate parasite that attaches to the abdomen of the Apis cerana and Apis mellifera honey bee and primarily feeds on bee fat body tissue, spreading both viruses and bacteria to the bee colony in the process. Additionally, they create open wounds on the bees and feed on bee larvae. Left untreated, most honey bee colonies will eventually succumb to this devastating pest. Thus, the Varroa mite is the parasite with possibly the most pronounced economic impact on the beekeeping industry.

The Varroa mite is known to only reproduce in a honey bee colony. Accordingly, treatment at the point of the hive is critical. Current treatments for Varroa mite infestation include harsh chemicals that persist in the hive either in their native state or as a metabolite, harming honey bees. In addition, Varroa mites in treated colonies can become resistant to these commercial chemical pesticides over time.

Accordingly, there are a number of disadvantages associated with currently available treatment for Varroa mite infestation. A biorational option for Varroa mite treatment (i.e., a Varroa mite pesticide that causes relatively no harm to humans or animals, and does little to no damage to the environment) is desperately needed.

### SUMMARY

Embodiments of the present disclosure solve one or more of the foregoing or other problems in the art with compositions, methods, and kits for use in: (1) preserving a beehive and/or bees associated with the beehive against Varroa destructor infestation-induced collapse or death by controlling, reducing, and/or eliminating a population of Varroa destructor associated with the beehive and/or bees associated with the beehive through targeted, phage-based, bactericidal and/or bacteriostatic activity against Bacillus sp. (e.g., Bacillus paralicheniformis), Hafnia sp. (e.g., Hafnia paralvei), and/or Escherichia sp. (e.g., Escherichia coli) in, internal to, or associated with Varroa destructor that is associated with the beehive and/or with bees associated with the beehive; (2) supporting the health, vitality, and/or longevity of a beehive and/or bees associated with the beehive by controlling, reducing, and/or eliminating a population of Varroa destructor associated with the beehive and/or bees associated with the beehive through targeted, phage-based, bactericidal and/or bacteriostatic activity against Bacillus sp. (e.g., Bacillus paralicheniformis), Hafnia sp. (e.g., Hafnia paralvei), and/or Escherichia sp. (e.g., Escherichia coli) in, internal to, or associated with Varroa destructor that is associated with the beehive and/or with bees associated with the beehive; (3) controlling, reducing, and/or eliminating a population of Varroa destructor associated with a beehive and/or bees associated with the beehive through targeted, phage-based, bactericidal and/or bacteriostatic activity against Bacillus sp. (e.g., Bacillus paralicheniformis), Hafnia sp. (e.g., Hafnia paralvei), and/or Escherichia sp. (e.g., Escherichia coli) in, internal to, or associated with Varroa destructor that is associated with the beehive and/or with bees associated with the beehive; or (4) targeted, phage-based, bactericidal and/or bacteriostatic activity against Bacillus sp. (e.g., Bacillus paralicheniformis), Hafnia sp. (e.g., Hafnia paralvei), and/or Escherichia sp. (e.g., Escherichia coli) in, internal to, or associated with Varroa destructor that is associated with the beehive and/or with bees associated with the beehive. The foregoing is/are accomplished by applying or administering to the beehive, or to bees associated with the beehive, a composition that includes one or more bacteriophage having (cellular) tropism for, or infectivity specific for, Bacillus sp. (e.g., Bacillus paralicheniformis), Hafnia sp. (e.g., Hafnia paralvei), and/or Escherichia sp. (e.g., Escherichia coli) bacteria in, internal to, or associated with Varroa destructor that is associated with the beehive and/or with bees associated with the beehive.

The (internal) microbiome of the Varroa destructor mite consists of the microscopic eukarya, archaea, bacteria and viruses living in the Varroa destructor mite (e.g., internal to the Varroa destructor mite). Many of these microbes are likely required for Varroa mite health, vitality, and life, with specific strains co-evolving optimized symbiotic properties such as nutritional aids in digestion or absorption, vitamin biosynthesis, antimicrobial/antibiotic toxins (against so-called “bad bacteria”), immune modulators and even modulators of mite behavior. Specific-coevolved strains can be targeted by naturally occurring bacteriophages that are isolated, characterized, and optionally combined for therapeutic optimization. Lysis and/or death of these strains can cause sickness, sterility, and/or death in the Varroa mite through loss of one of more of the above, beneficial properties conferred upon the Varroa mite by the bacterial strains. Moreover, lysis can cause release of toxins that may affect inflammatory or other pathways in the Varroa mite, leading ultimately to sickness, sterility, and/or death in the Varroa mite.

Bacteriophages are often highly specific for the bacteria they infect, commonly distinguishing different strains of a single species of bacteria. The present disclosure presents compositions and methods for utilizing bacteriophage specificity to target key bacteria in, internal to, and/or associated with the Varroa mite. This targeting lyses and/or kills the bacteria, which may render the Varroa mite sick and/or unable to thrive and/or replicate (through the disruption of key natural microbiota in, internal to, and/or associated with the Varroa mite.

The use of bacteriophages for inhibiting, lysing, and/or killing pathogenic (or “bad”) bacteria in a host/organism, in order to support, bolster, or restore health in the target host/organism, is well known. However, embodiments of the present disclosure target beneficial bacteria that are (1) present in, internal to, and/or associated with Varroa destructor mites, an obligate parasite of and/or associated with a beehive or with bees that are associated with the beehive, and/or (2) predicted to be essential (contributors) to the health, vitality, and/or reproductive capability of the Varroa destructor, thereby (i) decreasing the health/wellness of the parasitic mite and, thereby, (ii) supporting the health of the hive, which is not the target organism of the bacteriophage. Accordingly, rather than targeting “bad” bacteria for the benefit of the host organism, embodiments of the present disclosure target “good” bacteria to the detriment of the bacterial host organism—an obligate parasite (Varroa mite) to a further, parasitic host organism. This benefits the parasitic host organism (or ecological, biological system)—a beehive and/or bees thereof—rather than the bacterial host organism.

In at least one respect, this is possible due to the fact that different host species (Varroa mite vs. honeybee) have such different microbiomes or specific microbiotic strains thereof, that bacteriophage with narrow host range are able to differentiate between (“good”) bacteria of the honey bee and (“bad”) bacteria of the Varroa mite. In other words, the beneficial Varroa destructor mite bacteria may be targeted, leaving the honey bee microbiota intact due to the divergence of these two organisms in early evolutionary history and their resulting diverse lifestyles. The Varroa destructor mite is of the class Arachnida, while the honey bee is of the class Insecta. Although the Varroa destructor mite is an obligate parasite, it feeds on the fat body of the honey bee, a discrete body separate from the digestive system. Accordingly, bacteria from the Varroa destructor mite were isolated and compared with bacteria known to be the key beneficial bacteria to honey bee health, and those species in common were not utilized to ensure target specificity. For example, three of the bacteriophages isolated and utilized in the present disclosure are highly unique, showing only distant homology to any reported phages in the NCBI GenBank database.

Accordingly, the present disclosure relates to killing or sickening Varroa destructor associated with a beehive or honey bee colony, and particularly to compositions and methods for use in preserving a beehive or bees associated with the beehive against Varroa destructor infestation-induced collapse or death, or supporting the health, vitality, and longevity of a beehive or bees associated with the beehive by controlling, reducing, or eliminating a population of Varroa destructor associated with the beehive or bees associated with the beehive through targeted, phage-based, bactericidal or bacteriostatic activity against Bacillus sp. (e.g., Bacillus paralicheniformis), Hafnia sp. (e.g., Hafnia paralvei), and/or Escherichia sp. (e.g., Escherichia coli) present in, internal to, and/or associated with Varroa destructor that are associated with the beehive or with bees associated with the beehive, and specifically to compositions comprising one or more bacteriophage having cellular tropism for, or infectivity specific for, Bacillus sp. (e.g., Bacillus paralicheniformis), Hafnia sp. (e.g., Hafnia paralvei), and/or Escherichia sp. (e.g., Escherichia coli) in, internal to, and/or associated with Varroa destructor that is associated with the beehive or with bees associated with the beehive, and methods of manufacturing and using the same.

Aspects of the present disclosure, or the invention disclosed, recited, and/or claimed therein, include, comprise, and/or relate to compositions, methods, and kits for direct, phage-facilitated targeting of, or targeted, phage-based, bactericidal and/or bacteriostatic activity against Bacillus sp. (e.g., Bacillus paralicheniformis), Hafnia sp. (e.g., Hafnia paralvei), and/or Escherichia sp. (e.g., Escherichia coli) in, internal to, and/or associated with Varroa destructor that is associated with the beehive or with bees associated with the beehive, preferably for controlling, reducing, and/or eliminating a population of Varroa destructor associated with the beehive and/or bees associated with the beehive, more preferably for supporting the health, vitality, and/or longevity of the beehive and/or bees associated with the beehive and/or preserving the beehive and/or bees associated with the beehive against Varroa destructor infestation-induced collapse or death.

Illustrative compositions and kits comprise novel bacteriophage(s), bacteriophage cocktail(s), and/or bacteriophage formulation(s). The bacteriophage of the inventive compositions have (cellular) tropism for and/or infectivity specific for Bacillus sp. (e.g., Bacillus paralicheniformis), Hafnia sp. (e.g., Hafnia paralvei), and/or Escherichia sp. (e.g., Escherichia coli) in, internal to, and/or associated with Varroa destructor that is associated with the beehive or with bees associated with the beehive.

Illustrative (therapeutic and/or treatment) methods can comprise applying or administering to applying or administering to a beehive having Varroa destructor infestation, or to bees associated with the beehive, a composition that includes one or more bacteriophage having (cellular) tropism for, or infectivity specific for, Bacillus sp. (e.g., Bacillus paralicheniformis), Hafnia sp. (e.g., Hafnia paralvei), and/or Escherichia sp. (e.g., Escherichia coli) bacteria in, internal to, and/or associated with Varroa destructor that is associated with the beehive or with bees associated with the beehive. Illustrative methods can comprise infecting the Varroa destructor associated with the beehive and/or bees associated with the beehive with one or more of the bacteriophage by applying or administering the composition to the beehive or to bees associated with the beehive. Mechanistically, but without being bound to any particular theory, Bacillus sp. (e.g., Bacillus paralicheniformis), Hafnia sp. (e.g., Hafnia paralvei), and/or Escherichia sp. (e.g., Escherichia coli) in, internal to, and/or associated with Varroa destructor that is associated with the beehive and/or with bees associated with the beehive can support the health, vitality, and/or reproduction of the Varroa destructor. Targeted, phage-based or phage-facilitated bactericidal and/or bacteriostatic activity against the Bacillus sp. (e.g., Bacillus paralicheniformis), Hafnia sp. (e.g., Hafnia paralvei), and/or Escherichia sp. (e.g., Escherichia co/i) in, internal to, and/or associated with Varroa destructor that is associated with the beehive and/or with bees associated with the beehive can control, reduce, and/or eliminate a population of the Varroa destructor associated with a beehive and/or bees associated with the beehive, thereby supporting the health, vitality, and/or longevity of the beehive and/or bees associated with the beehive and/or preserving the beehive and/or bees associated with the beehive against Varroa destructor infestation-induced collapse or death. Specifically, phage-induced death or lysis of the Bacillus sp. (e.g., Bacillus paralicheniformis), Hafnia sp. (e.g., Hafnia paralvei), and/or Escherichia sp. (e.g., Escherichia coli) in, internal to, and/or associated with Varroa destructor that is associated with the beehive and/or with bees associated with the beehive can result in death, growth or maturation cessation, and/or reproductive sterility of the Varroa destructor associated with a beehive and/or bees associated with the beehive, thereby controlling, reducing, and/or eliminating a population of the Varroa destructor associated with a beehive and/or bees associated with the beehive, which benefits, enhances, and/or supports the health, vitality, and/or longevity of the beehive and/or bees associated with the beehive, thereby preserving the beehive and/or bees associated with the beehive against Varroa destructor infestation-induced collapse or death.

Accordingly, aspects of the present disclosure, or the invention disclosed, recited, and/or claimed therein, include, comprise, and/or relate to compositions, methods, and kits for targeted “Varroacidal” and/or “Varroastatic” treatment of a beehive and/or bees associated with the beehive, through targeted, phage-based, bactericidal and/or bacteriostatic treatment against Bacillus sp. (e.g., Bacillus paralicheniformis) Hafnia sp. (e.g., Hafnia paralvei), and/or Escherichia sp. (e.g., Escherichia coli) in, internal to, and/or associated with Varroa destructor that is associated with the beehive and/or with bees associated with the beehive.

Thus, embodiment of the present disclosure include product(s) and/or method(s) that provide a natural, organic, sustainable, “green”, and/or biorational option for or alternative to traditional (chemical) Varroa mite treatment.

In a first (or at least a first) aspect, embodiments of the present disclosure include composition(s) for use in treating Varroa destructor infestation in a beehive having Varroa destructor infestation.

Illustrative composition(s) of the present disclosure include one or more bacteriophage having a genome with a nucleic acid sequence selected from the group consisting of: SEQ ID NO. 1 through SEQ ID NO. 13, or having a genome with at least 70% sequence identity to one of SEQ ID NO. 1 through SEQ ID NO. 13, wherein each of the one or more bacteriophage has (a respective) specificity or cellular tropism for one or more strain of Bacillus sp. (e.g., Bacillus paralicheniformis), one or more strain of Hafnia sp., (e.g., Hafnia paralvei), or one or more strain of Escherichia sp. (e.g., Escherichia coli) present in, internal to, and/or associated with Varroa destructor that is associated with the beehive and/or the bees associated with the beehive. Illustrative composition(s) of the present disclosure further include a carrier or excipient (in which the one or more bacteriophage is/are disposed, carried, and/or contained).

In some embodiments, the composition includes two or more, preferably three or more, more preferably four or more, still more preferably five or more, still more preferably six or more, still more preferably seven or more, still more preferably eight or more, still more preferably nine or more, still more preferably ten or more, still more preferably eleven or more, still more preferably twelve or more, most preferably thirteen bacteriophage having respective genomes with respective nucleic acid sequences selected from the group consisting of SEQ ID NO. 1 through SEQ ID NO. 13.

In some embodiments, (each of) the (two or more, three or more, four or more, five or more, six or more, seven or more, eight or more, nine or more, ten or more, eleven or more, twelve or more, or thirteen) bacteriophage(s) have or comprise, compared to other bacteriophage in the composition (i) different host cell receptor specificity for attachment and/or (ii) less than or equal to 99% genomic sequence identity, preferably less than or equal to 98% genomic sequence identity, more preferably less than or equal to 97% genomic sequence identity, still more preferably less than or equal to 96% genomic sequence identity, still more preferably less than or equal to 95% genomic sequence identity, still more preferably less than or equal to 94% genomic sequence identity, still more preferably less than or equal to 93% genomic sequence identity, still more preferably less than or equal to 92% genomic sequence identity, still more preferably less than or equal to 91% genomic sequence identity, still more preferably less than or equal to 90% genomic sequence identity, still more preferably less than or equal to 89% genomic sequence identity, still more preferably less than or equal to 88% genomic sequence identity, still more preferably less than or equal to 87% genomic sequence identity, still more preferably less than or equal to 86% genomic sequence identity, still more preferably less than or equal to 85% genomic sequence identity, still more preferably less than or equal to 84% genomic sequence identity, still more preferably less than or equal to 83% genomic sequence identity, still more preferably less than or equal to 82% genomic sequence identity, still more preferably less than or equal to 81% genomic sequence identity, still more preferably less than or equal to 80% genomic sequence identity.

In some embodiments, (each of) the (one or more, two or more, three or more, four or more, five or more, six or more, seven or more, eight or more, nine or more, ten or more, eleven or more, twelve or more, or thirteen) bacteriophage(s) has a genome with a nucleic acid sequence having at least 75% sequence identity, preferably at least 78% sequence identity, more preferably at least 80% sequence identity, still more preferably at least 82% sequence identity, still more preferably at least 85% sequence identity, still more preferably at least 88% sequence identity, still more preferably at least 90% sequence identity, still more preferably at least 91% sequence identity, still more preferably at least 92% sequence identity, still more preferably at least 93% sequence identity, still more preferably at least 94% sequence identity, still more preferably at least 95% sequence identity, still more preferably at least 96% sequence identity, still more preferably at least 97% sequence identity, still more preferably at least 98% sequence identity, still more preferably at least 99% sequence identity to one of SEQ ID NO. 1 through SEQ ID NO. 13.

In some embodiments, (each of) the (one or more, two or more, three or more, four or more, five or more, six or more, seven or more, eight or more, nine or more, ten or more, eleven or more, twelve or more, or thirteen) bacteriophage(s) is/are present in the composition at greater than or equal to about 1×10⁴ plaque forming units per milliliter (PFU/mL) of the composition or greater than or equal to about 1×10⁴ PFU per milligram (PFU/mg) of the composition, preferably greater than or equal to about 1×10⁵ plaque forming units per milliliter PFU/mL of the composition or greater than or equal to about 1×10⁵ PFU/mg of the composition, more preferably greater than or equal to about 1×10⁶ PFU/mL of the composition or greater than or equal to about 1×10⁶ PFU/mg of the composition, still more preferably greater than or equal to about 1×10⁷ PFU/mL of the composition or greater than or equal to about 1×10⁷ PFU/mg of the composition, still more preferably greater than or equal to about 1×10⁸ PFU/mL of the composition or greater than or equal to about 1×10⁸ PFU/mg of the composition, still more preferably greater than or equal to about 1×10⁹ PFU/mL of the composition or greater than or equal to about 1×10⁹ PFU/mg of the composition, still more preferably greater than or equal to about 1×10¹⁰ PFU/mL of the composition or greater than or equal to about 1×10¹⁰ PFU/mg of the composition, still more preferably greater than or equal to about 1×10¹¹ PFU/mL of the composition or greater than or equal to about 1×10¹¹ PFU/mg of the composition, still more preferably greater than or equal to about 1×10¹² PFU/mL of the composition or greater than or equal to about 1×10¹² PFU/mg of the composition.

In some embodiments, (each of) the (one or more, two or more, three or more, four or more, five or more, six or more, seven or more, eight or more, nine or more, ten or more, eleven or more, twelve or more, or thirteen) bacteriophage(s) is/are lytic and/or has lytic activity against the one or more strain of Bacillus sp. (e.g., Bacillus paralicheniformis), one or more strain of Hafnia sp., (e.g., Hafnia paralvei) and/or one or more strain of Escherichia sp. (e.g., Escherichia coil) present in, internal to, and/or associated with Varroa destructor that is associated with the beehive and/or with the bees associated with the beehive.

In some embodiments, (each of) the (one or more, two or more, three or more, four or more, five or more, six or more, seven or more, eight or more, nine or more, ten or more, eleven or more, twelve or more, or thirteen) bacteriophage(s) is/are not lysogenic and/or does not have lysogenic activity against the one or more strain of Bacillus sp. (e.g., Bacillus paralicheniformis), the one or more strain of Hafnia sp., (e.g., Hafnia paralvei), and/or the one or more strain of Escherichia sp. (e.g., Escherichia coli) present in, internal to, and/or associated with Varroa destructor that is associated with the beehive and/or with the bees associated with the beehive.

In some embodiments, applying or administering the composition to a beehive having Varroa destructor infestation, or to bees associated with the beehive, is effective to: (1) cause bacteriophage-induced death or lysis of one or more strain of Bacillus sp. (e.g., Bacillus paralicheniformis), one or more strain of Hafnia sp., (e.g., Hafnia paralvei), or one or more strain of Escherichia sp. (e.g., Escherichia coli) present in, internal to, and/or associated with Varroa destructor that is associated with the beehive and/or with the bees associated with the beehive; (2) cause death of Varroa destructor associated with the beehive and/or the bees; and/or (3) inhibit reproduction, maturation, and/or growth in Varroa destructor or a population of Varroa destructor associated with the beehive and/or the bees.

In some embodiments, the composition includes a mixture or cocktail of bacteriophages (i.e., a bacteriophage cocktail), including two or more sets of bacteriophage(s), selected from the group consisting of: (i) a first set of bacteriophage that includes one or more bacteriophage, each having a genome with a nucleic acid sequence selected from the group consisting of SEQ ID NO. 1 through SEQ ID NO. 5, or having at least 70% sequence identity to one of SEQ ID NO. 1 through SEQ ID NO. 5, wherein each bacteriophage in the first set has specificity or cellular tropism for at least one strain of Bacillus sp. (e.g., Bacillus paralicheniformis); (ii) a second set of bacteriophage that includes one or more bacteriophage, each having a genome with a nucleic acid sequence selected from the group consisting of SEQ ID NO. 6 through SEQ ID NO. 9, or having at least 70% sequence identity to one of SEQ ID NO. 6 through SEQ ID NO. 9, wherein each bacteriophage in the second set has specificity or cellular tropism for at least one strain of Hafnia sp. (e.g., Hafnia paralvei); and/or (iii) a third set of bacteriophage that includes one or more bacteriophage, each having a genome with a nucleic acid sequence selected from the group consisting of SEQ ID NO. 10 through SEQ ID NO. 13, or having at least 70% sequence identity to one of SEQ ID NO. 10 through SEQ ID NO. 13, wherein each bacteriophage in the third set has specificity or cellular tropism for at least one strain of Escherichia sp. (e.g., Escherichia coli).

In some embodiments, the first set of bacteriophage can include two or more bacteriophage, preferably three or more bacteriophage, more preferably four or more bacteriophage, each having a genome with a nucleic acid sequence selected from the group consisting of SEQ ID NO. 1 through SEQ ID NO. 5, or having at least 70% sequence identity to one of SEQ ID NO. 1 through SEQ ID NO. 5, wherein each bacteriophage in the first set has specificity or cellular tropism for at least one strain of Bacillus sp. (e.g., Bacillus paralicheniformis).

In some embodiments, the second set of bacteriophage can include two or more bacteriophage, preferably three or more bacteriophage, more preferably four or more bacteriophage, each having a genome with a nucleic acid sequence selected from the group consisting of SEQ ID NO. 6 through SEQ ID NO. 9, or having at least 70% sequence identity to one of SEQ ID NO. 6 through SEQ ID NO. 9, wherein each bacteriophage in the second set has specificity or cellular tropism for at least one strain of Hafnia sp. (e.g., Hafnia paralvei)

In some embodiments, the third set of bacteriophage can include two or more bacteriophage, preferably three or more bacteriophage, more preferably four or more bacteriophage, each having a genome with a nucleic acid sequence selected from the group consisting of SEQ ID NO. 10 through SEQ ID NO. 13, or having at least 70% sequence identity to one of SEQ ID NO. 10 through SEQ ID NO. 13, wherein each bacteriophage in the third set has specificity or cellular tropism for at least one strain of Escherichia sp. (e.g., Escherichia coli).

In some embodiments, (each of) the (one or more, two or more, three or more, or four or more) bacteriophage(s) in the first set of bacteriophage has a genome with a nucleic acid sequence having at least 75% sequence identity, preferably at least 78% sequence identity, more preferably at least 80% sequence identity, still more preferably at least 82% sequence identity, still more preferably at least 85% sequence identity, still more preferably at least 88% sequence identity, still more preferably at least 90% sequence identity, still more preferably at least 91% sequence identity, still more preferably at least 92% sequence identity, still more preferably at least 93% sequence identity, still more preferably at least 94% sequence identity, still more preferably at least 95% sequence identity, still more preferably at least 96% sequence identity, still more preferably at least 97% sequence identity, still more preferably at least 98% sequence identity, still more preferably at least 99% sequence identity to one of SEQ ID NO. 1 through SEQ ID NO.

In some embodiments, (each of) the (one or more, two or more, three or more, or four or 30 more) bacteriophage(s) in the second set of bacteriophage has a genome with a nucleic acid sequence having at least 75% sequence identity, preferably at least 78% sequence identity, more preferably at least 80% sequence identity, still more preferably at least 82% sequence identity, still more preferably at least 85% sequence identity, still more preferably at least 88% sequence identity, still more preferably at least 90% sequence identity, still more preferably at least 91% sequence identity, still more preferably at least 92% sequence identity, still more preferably at least 93% sequence identity, still more preferably at least 94% sequence identity, still more preferably at least 95% sequence identity, still more preferably at least 96% sequence identity, still more preferably at least 97% sequence identity, still more preferably at least 98% sequence identity, still more preferably at least 99% sequence identity to one of SEQ ID NO. 6 through SEQ ID NO. 9.

In some embodiments, (each of) the (one or more, two or more, three or more, or four or more) bacteriophage(s) in the third set of bacteriophage has a genome with a nucleic acid sequence having at least 75% sequence identity, preferably at least 78% sequence identity, more preferably at least 80% sequence identity, still more preferably at least 82% sequence identity, still more preferably at least 85% sequence identity, still more preferably at least 88% sequence identity, still more preferably at least 90% sequence identity, still more preferably at least 91% sequence identity, still more preferably at least 92% sequence identity, still more preferably at least 93% sequence identity, still more preferably at least 94% sequence identity, still more preferably at least 95% sequence identity, still more preferably at least 96% sequence identity, still more preferably at least 97% sequence identity, still more preferably at least 98% sequence identity, still more preferably at least 99% sequence identity to one of SEQ ID NO. 10 through SEQ ID NO. 13.

In some embodiments, (each of) the (one or more, two or more, three or more, or four or more) bacteriophage(s) in each of the first set of bacteriophage, the second set of bacteriophage, and the third set of bacteriophage is/are present in the composition at greater than or equal to about 1×10⁴ plaque forming units per milliliter (PFU/mL) of the composition or greater than or equal to about 1×10⁴ PFU per milligram (PFU/mg) of the composition, preferably greater than or equal to about 1×10⁵ plaque forming units per milliliter PFU/mL of the composition or greater than or equal to about 1×10⁵ PFU/mg of the composition, more preferably greater than or equal to about 1×10⁶ PFU/mL of the composition or greater than or equal to about 1×10⁶ PFU/mg of the composition, still more preferably greater than or equal to about 1×10⁷ PFU/mL of the composition or greater than or equal to about 1×10⁷ PFU/mg of the composition, still more preferably greater than or equal to about 1×10⁸ PFU/mL of the composition or greater than or equal to about 1×10⁸ PFU/mg of the composition, still more preferably greater than or equal to about 1×10⁹ PFU/mL of the composition or greater than or equal to about 1×10⁹ PFU/mg of the composition, still more preferably greater than or equal to about 1×10¹⁰ PFU/mL of the composition or greater than or equal to about 1×10¹⁰ PFU/mg of the composition, still more preferably greater than or equal to about 1×10¹¹ PFU/mL of the composition or greater than or equal to about 1×10¹¹ PFU/mg of the composition, still more preferably greater than or equal to about 1×10¹² PFU/mL of the composition or greater than or equal to about 1×10¹² PFU/mg of the composition.

In some embodiments, (each of) the (one or more, two or more, three or more, or four or more) bacteriophage(s), or the respective bacteriophage(s), in each of the first set of bacteriophage, the second set of bacteriophage, and the third set of bacteriophage is/are (respectively or each) lytic and/or have lytic activity against the one or more strain of Bacillus sp. (e.g., Bacillus paralicheniformis), the one or more strain of Hafnia sp. (e.g., Hafnia paralvel), and the one or more strain of Escherichia sp. (e.g., Escherichia coli), respectively.

In some embodiments, (each of) the (one or more, two or more, three or more, or four or more) bacteriophage(s), or the respective bacteriophage(s), in each of the first set of bacteriophage, the second set of bacteriophage, and the third set of bacteriophage is/are (respectively or each) not lysogenic and/or do not have lysogenic activity against the one or more strain of Bacillus sp. (e.g., Bacillus paralicheniformis), the one or more strain of Hafnia sp. (e.g., Hafnia paralvei), and the one or more strain of Escherichia sp. (e.g., Escherichia coli), respectively.

In some embodiments, the mixture or cocktail of bacteriophages (i.e., a bacteriophage cocktail), includes the first set of bacteriophage, the second set of bacteriophage, and the third set of bacteriophage.

In some embodiments, the (respective) bacteriophage(s) of the first set of bacteriophage each have or comprise, compared to other bacteriophage in the first set (i) different host cell receptor specificity for attachment and/or (ii) less than or equal to 99% genomic sequence identity, preferably less than or equal to 98% genomic sequence identity, more preferably less than or equal to 97% genomic sequence identity, still more preferably less than or equal to 96% genomic sequence identity, still more preferably less than or equal to 95% genomic sequence identity, still more preferably less than or equal to 94% genomic sequence identity, still more preferably less than or equal to 93% genomic sequence identity, still more preferably less than or equal to 92% genomic sequence identity, still more preferably less than or equal to 91% genomic sequence identity, still more preferably less than or equal to 90% genomic sequence identity, still more preferably less than or equal to 89% genomic sequence identity, still more preferably less than or equal to 88% genomic sequence identity, still more preferably less than or equal to 87% genomic sequence identity, still more preferably less than or equal to 86% genomic sequence identity, still more preferably less than or equal to 85% genomic sequence identity, still more preferably less than or equal to 84% genomic sequence identity, still more preferably less than or equal to 83% genomic sequence identity, still more preferably less than or equal to 82% genomic sequence identity, still more preferably less than or equal to 81% genomic sequence identity, still more preferably less than or equal to 80% genomic sequence identity.

In some embodiments, the (respective) bacteriophage(s) of the second set of bacteriophage each have or comprise, compared to other bacteriophage in the second set (i) different host cell receptor specificity for attachment and/or (ii) less than or equal to 99% genomic sequence identity, preferably less than or equal to 98% genomic sequence identity, more preferably less than or equal to 97% genomic sequence identity, still more preferably less than or equal to 96% genomic sequence identity, still more preferably less than or equal to 95% genomic sequence identity, still more preferably less than or equal to 94% genomic sequence identity, still more preferably less than or equal to 93% genomic sequence identity, still more preferably less than or equal to 92% genomic sequence identity, still more preferably less than or equal to 91% genomic sequence identity, still more preferably less than or equal to 90% genomic sequence identity, still more preferably less than or equal to 89% genomic sequence identity, still more preferably less than or equal to 88% genomic sequence identity, still more preferably less than or equal to 87% genomic sequence identity, still more preferably less than or equal to 86% genomic sequence identity, still more preferably less than or equal to 85% genomic sequence identity, still more preferably less than or equal to 84% genomic sequence identity, still more preferably less than or equal to 83% genomic sequence identity, still more preferably less than or equal to 82% genomic sequence identity, still more preferably less than or equal to 81% genomic sequence identity, still more preferably less than or equal to 80% genomic sequence identity.

In some embodiments, the (respective) bacteriophage(s) of the third set of bacteriophage each have or comprise, compared to other bacteriophage in the third set (i) different host cell receptor specificity for attachment and/or (ii) less than or equal to 99% genomic sequence identity, preferably less than or equal to 98% genomic sequence identity, more preferably less than or equal to 97% genomic sequence identity, still more preferably less than or equal to 96% genomic sequence identity, still more preferably less than or equal to 95% genomic sequence identity, still more preferably less than or equal to 94% genomic sequence identity, still more preferably less than or equal to 93% genomic sequence identity, still more preferably less than or equal to 92% genomic sequence identity, still more preferably less than or equal to 91% genomic sequence identity, still more preferably less than or equal to 90% genomic sequence identity, still more preferably less than or equal to 89% genomic sequence identity, still more preferably less than or equal to 88% genomic sequence identity, still more preferably less than or equal to 87% genomic sequence identity, still more preferably less than or equal to 86% genomic sequence identity, still more preferably less than or equal to 85% genomic sequence identity, still more preferably less than or equal to 84% genomic sequence identity, still more preferably less than or equal to 83% genomic sequence identity, still more preferably less than or equal to 82% genomic sequence identity, still more preferably less than or equal to 81% genomic sequence identity, still more preferably less than or equal to 80% genomic sequence identity.

In some embodiments, applying or administering the phage cocktail-containing composition to a beehive having Varroa destructor infestation, or to bees associated with the beehive, is effective to: (1) cause bacteriophage-induced death or lysis of one or more strain of Bacillus sp. (e.g., Bacillus paralicheniformis) and/or one or more strain of Hafnia sp. (e.g., Hafnia paralvei) and/or one or more strain of Escherichia sp. (e.g., Escherichia coli) present in, internal to, and/or associated with Varroa destructor that is associated with the beehive and/or with the bees associated with the beehive; (2) cause death of Varroa destructor associated with the beehive and/or the bees; and/or (3) inhibit reproduction, maturation, and/or growth in Varroa destructor or a population of Varroa destructor associated with the beehive and/or the bees.

In one or more of the various embodiments, the carrier or excipient can comprise suitable components, as known in the art. Illustratively, the carrier or excipient can comprise water or suitable liquid base.

Illustratively, the carrier or excipient can comprise a buffer or buffering agent (in water). Illustratively, the carrier or excipient can comprise a buffered solution (e.g., buffering agent(s) in water). Buffering agents can be suitable for buffering the composition (in liquid/water) at any suitable pH (e.g., greater than, less than, equal to, between, and/or about pH 6.5, 6.6, 6.7, 6.8, 6.9, 7.0, 7.1, 72, 7.3, 7.4, 7.5, 7.6, 0.7.7, 7.8, 7.9, 8.0, 8.1, 8.2, 8.3, 8.4, or 8.5). Illustratively, the buffering agent can be or comprise a sodium phosphate buffer (in water). In some embodiments, the buffer can be or comprise (greater than or equal to) about 25 mM, 50 mM, 100 mM 150 mM, or 200 mM sodium phosphate buffer (pH 7.0-7.9). In some embodiments, the buffer or buffering agent can be or comprise (greater than or equal to) about 50 mM sodium phosphate buffer (pH ˜7.4).

In at least one embodiment, the carrier or excipient can be or compose SM buffer (in water), as known in the art.

Illustratively, the carrier or excipient can comprise one or more salts. In some embodiments, the salt(s) can be or comprise NaCl (or CaCl, MgCl, KCl), or corresponding or other anion/cation salt combination, as known in the art and suitable for bee/beehive applications. In some embodiments, the salt(s) (e.g., NaCl) can be included in the composition (or carrier or excipient thereof) at a concentration of greater than, less than, equal to, between, and/or about 1 g/L, 2 g/L, 3 g/L, 4 g/L, 4.5 g/L, 5 g/L, 5.1 g/L, 5.2 g/L, 5.3 g/L, 5.4 g/L, 5.5 g/L, 5.6 g/L, 5.7 g/L, g/L, 5.9 g/L, 6.0 g/L, 6.5 g/L, 7 g/L, etc. or greater than, less than, equal to, between, and/or about 50 mM, 60 mM, 70 mM, 75 mM, 80 mM, 85 mM, 90 mM, 95 mM, 100 mM, 105 mM, 110 mM, 115 mM, 120 mM, 125 mM, 130 mM, 140 mM, 150 mM, etc. In some embodiments, the salt can be or comprise (greater than or equal to) about 5.8 g/L NaCl (or (greater than or equal to) about 100 mM).

Alternatively, or in addition, the salt can be or comprise MgSO4 (e.g., MgSO4·7H2O) or a corresponding or other anion/cation salt combination, as known in the art and suitable for bee/beehive applications. In some embodiments, the salt(s) (e.g., NaCl) can be included in the composition (or carrier or excipient thereof) at a concentration of greater than, less than, equal to, between, and/or about 0.1 g/L, 0.25 g/L, 0.5 g/L, 1 g/L, 1.1 g/L, 1.2 g/L, 1.3 g/L, 1.4 g/L, 1.5 g/L, 1.6 g/L, 1.7 g/L, 1.8 g/L, 1.9 g/L, 2.0 g/L, 2.1 g/L, 2.2 g/L, 2.3 g/L, 2.4 g/L, 2.5 g/L, 2.6 g/L, 2.7 g/L, 2.8 g/L, 2.9 g/L, 3.0 g/L, 3.5 g/L, 4 g/L, etc., or greater than, less than, equal to, between, and/or about 0.5 mM, 1 mM, 2 mM, 3 mM, 4 mM, 5 mM, 6 mM, 7 mM, 7.5 mM, 8 mM, 8.5 mM, 9 mM, 11 mM, 12 mM, 13 mM, 14 mM, 15 mM, etc. In some embodiments, the salt can be or comprise (greater than or equal to) about 2 g/L MgSO4·7H2O (or (greater than or equal to) about 8 mM).

Illustratively, the carrier or excipient can comprise one or more peptides.

Illustratively, the carrier or excipient can comprise a yeast extract.

Illustratively, the carrier or excipient can be or comprise greater than or equal to about 50 mM sodium phosphate buffer (pH 7.4), 5.8 g/L NaCL (100 mM final), 2 g/L MgSO4·7H2O (8 mM final).

In a second (or at least a second) aspect, embodiments of the present disclosure include a kit.

In some embodiments, the kit can include two or more compositions in accordance with any of the embodiment of the first aspect of the present disclosure. Illustratively, certain compositions of the present disclosure may be optimal or more effective for spring, summer, fall, or winter applications or treatments, or any combination thereof, than certain other compositions of the present disclosure. For instance, one or more illustrative compositions may be optimal for spring applications or treatments, summer applications or treatments, spring/summer applications or treatments, fall applications or treatments, spring/fall applications or treatments, summer/fall applications or treatments, winter applications or treatments, winter/spring applications or treatments, or fall/winter applications or treatments.

In some embodiments, the kit can include one or more compositions in accordance with any of the embodiment of the first aspect of the present disclosure, and one or more probiotic compositions (aimed at improving bee and/or hive health). The probiotic composition(s) of the present disclosure can include one or more (or a cocktail of) probiotic bacteria know to support and/or improve bee and/or hive health. Illustrative probiotic bacteria can support and/or improve digestion, nutrient absorption, and/or overall health and wellness in the bees. Such probiotic bacteria will be apparent or known to those skilled in the art.

In a third aspect, embodiments of the present disclosure include a method of treating Varroa destructor infestation in a beehive.

In some embodiments, the method can involve or include the step of applying or administering to a beehive having Varroa destructor infestation, or to bees associated with the beehive, a composition in accordance with any of the embodiment of the first aspect of the present disclosure.

In some embodiments, the method can involve or include the step of applying or administering to a beehive having Varroa destructor infestation, or to bees associated with the beehive, two or more of the compositions according to any of the embodiment of the first aspect of the present disclosure.

In some embodiments, the method can involve or include the step of applying or administering to a beehive having Varroa destructor infestation, or to bees associated with the beehive, compositions included in a kit in accordance with any of the embodiment of the second aspect of the present disclosure.

In some embodiments, the method can involve or include the step of applying or administering to a beehive having Varroa destructor infestation, or to bees associated with the beehive, a composition that includes (i) one or more bacteriophage having specificity or cellular tropism for one or more strain of Bacillus sp. (e.g., Bacillus paralicheniformis), one or more strain of Hafnia sp. (e.g., Hafnia paralvel), or one or more strain of Escherichia sp. (e.g., Escherichia coli) present in, internal to, and/or associated with Varroa destructor that is associated with the beehive and/or with the bees associated with the beehive, and (ii) a carrier or excipient (in which the one or more bacteriophage is/are disposed, carried, and/or contained).

In some embodiments, the composition comprises two or more bacteriophage, preferably three or more bacteriophage, more preferably four or more bacteriophage, still more preferably five or more bacteriophage, still more preferably six or more bacteriophage, still more preferably seven or more bacteriophage, still more preferably eight or more bacteriophage, still more preferably nine or more bacteriophage, still more preferably ten or more bacteriophage, still more preferably eleven or more bacteriophage, still more preferably twelve or more bacteriophage, most preferably thirteen bacteriophage, each having specificity or cellular tropism for one or more strain of bacteria selected from the group consisting of Bacillus sp. (e.g., Bacillus paralicheniformis), Hafnia sp. (e.g., Hafnia paralvei), and Escherichia sp. (e.g., Escherichia coli) present in, internal to, and/or associated with Varroa destructor that is associated with the beehive and/or with the bees associated with the beehive.

In some embodiments, the composition comprises: (i) a first bacteriophage having specificity or cellular tropism for Bacillus sp. (e.g., Bacillus paralicheniformis); (ii) a second bacteriophage having specificity or cellular tropism for Hafnia sp. (e.g., Hafnia paralvei); and (iii) a third bacteriophage having specificity or cellular tropism for Escherichia sp. (e.g., Escherichia coli).

In some embodiments, the composition comprises: (i) a first set of bacteriophage comprising two or more bacteriophage, preferably three or more bacteriophage, more preferably four or more bacteriophage, each having specificity or cellular tropism for Bacillus sp. (e.g., Bacillus paralicheniformis); (ii) a second set of bacteriophage comprising two or more bacteriophage, preferably three or more bacteriophage, more preferably four or more bacteriophage, each having specificity or cellular tropism for Hafnia sp. (e.g., Hafnia paralvei); and/or (iii) a third set of bacteriophage comprising two or more bacteriophage, preferably three or more bacteriophage, more preferably four or more bacteriophage, each having specificity or cellular tropism for Escherichia sp. (e.g., Escherichia coli).

In some embodiments, the step of applying or administering any of the foregoing and/or disclosed composition to the beehive, or to the bees associated with the beehive, can include or involve delivering (applying or administering) the composition to the beehive once or twice a week by one or more (e.g., several) delivery methods including or selected from the group consisting of: ultralow volume fogging or surface acoustic wave nebulization of a liquid or other suitable sample, (air-based or airless) delivery of a lyophilized power or liquid substance set into the beehive, which delivers the bacteriophages through a combination of bee movement and/or evaporation throughout the hive, and so forth.

In some embodiments, the step of applying or administering any of the foregoing and/or disclosed composition to the beehive, or to the bees associated with the beehive, is effective to: (1) cause bacteriophage-induced death or lysis of one or more strain of Bacillus sp. (e.g., Bacillus paralicheniformis), and/or one or more strain of Hafnia sp. (e.g., Hafnia paralvei) and/or one or more strain of Escherichia sp. (e.g., Escherichia coli) present in, internal to, and/or associated with Varroa destructor that is associated with the beehive and/or with the bees associated with the beehive; (2) cause death of Varroa destructor associated with the beehive and/or the bees; and/or (3) inhibit reproduction, maturation, and/or growth in Varroa destructor or a population of Varroa destructor associated with the beehive and/or the bees.

In another aspect, embodiments of the present disclosure include a process of preparing a composition for use in treating Varroa destructor infestation in a beehive having Varroa destructor infestation.

In some embodiments, the process includes the step(s) of obtaining (one or more strains of) bacteria from Varroa destructor (e.g., from inside Varroa destructor), the (one or more strains of) bacteria preferably selected from the group consisting of at least one strain of Bacillus sp. (e.g., Bacillus paralicheniformis), at least one strain of Hafnia sp. (e.g., Hafnia paralvei), and at least one strain of Escherichia sp. (e.g., Escherichia coli).

In some embodiments, the step of obtaining the one or more strains of bacteria can comprise isolating the Varroa destructor mites from the beehive (to obtain the bacteria therefrom).

In some embodiments, the step of obtaining the one or more strains of bacteria can comprise (optionally) sterilizing (the surface or exterior of) the Varroa destructor mites. In some embodiments, sterilizing (the surface or exterior of) the Varroa destructor mites can include or be by exposure to UV light. In some embodiments, sterilizing (the surface or exterior of) the Varroa destructor mites can avoid, be devoid of, or not include exposure to one or more (or any) chemical sterilizing agent(s), such as ethanol, methanol, ammonia, bleach, etc. Illustratively, and without being bound to any particular theory, use of such sterilizing agents may be problematic, as an amount of sterilizing agent ingested by the Varroa mite(s) may be sufficient to kill internal bacteria, which would negate the step of isolating internal bacteria.

In some embodiments, the step of obtaining the one or more strains of bacteria can comprise (optionally) disrupting or homogenizing the (optionally sterilized) Varroa destructor mites. In some embodiments, the disrupting or homogenizing can include or be by sterile mortar and pestle, bead-beating, or any other suitable mite disruption or homogenizing method known in the art. In some embodiments, the disrupting or homogenizing can avoid, be devoid of, or not include one or more chemical lysis or disrupting agent(s).

In some embodiments, the process includes the step(s) of contacting the bacteria with a biological sample containing bacteriophage. In some embodiments, the biological sample preferably contains naturally-occurring bacteriophage.

In one or more embodiments, the biological sample can comprise soil, plant material, sewage, or sewage water. In at least one preferred embodiment, the biological sample comprises sewage or sewage water. In at least one preferred embodiment, the sewage or sewage water can comprise human biological waste. In at least one preferred embodiment, the biological sample containing bacteriophage is not taken from the beehive or the bees. In an alternative embodiment, the biological sample containing bacteriophage is taken from the beehive or the bees.

In at least one respect, obtaining (naturally-occurring) bacteriophage from (human) sewage, sewer water, waste, etc. for the purpose of isolating bacteriophage against (or having specificity or cellular tropism for) beneficial bacteria internal to the Varroa mite is an unexpected, unpredictable approach, yielding surprising and/or unexpected beneficial results.

In some embodiments, the process includes the step(s) of incubating the bacteria with the bacteriophage in an enrichment culture.

In some embodiments, the process includes the step(s) of isolating enriched bacteriophage from the enrichment culture.

In some embodiments, the process includes the step(s) of purifying the isolated enriched bacteriophage to obtain one or more enriched bacteriophage strains.

In some embodiments, the enriched bacteriophage are preferably more numerous in the enrichment culture than they are in the biological sample.

In some embodiments, the process includes the step(s) of characterizing the one or more enriched bacteriophage strains.

In some embodiments, the step(s) of characterizing the one or more enriched bacteriophage strains can include sequencing respective genomes of each of the one or more enriched bacteriophage strains.

In some embodiments, the step(s) of characterizing the one or more enriched bacteriophage strains can include selecting bacteriophage strain(s) having a genome devoid of toxin genes, virulence factor genes, and/or integrase genes.

In some embodiments, the step(s) of characterizing the one or more enriched bacteriophage strains can include optionally determining a level of genomic redundancy between the one or more enriched bacteriophage strains.

In some embodiments, the step(s) of characterizing the one or more enriched bacteriophage strains can include measuring lytic activity of the one or more enriched bacteriophage strains.

In some embodiments, the step(s) of characterizing the one or more enriched bacteriophage strains can include selecting bacteriophage strain(s) that are lytic and/or not lysogenic.

In some embodiments, the step(s) of characterizing the one or more enriched bacteriophage strains can include determining specificity or cellular tropism of the one or more enriched bacteriophage strain(s). In at least one aspect the tropism comprises a narrow host range that includes the one or more strains of Bacillus sp. (e.g., Bacillus parahcheniformis), Hafnia sp. (e.g., Hafnia paralvei), or Escherichia sp. (e.g., Escherichia coli). present in the Varroa mite.

In some embodiments, the step(s) of characterizing the one or more enriched bacteriophage strains can include selecting bacteriophage strain(s) with specificity or cellular tropism for at least one of the one or more strains of bacteria from (or internal to) Varroa destructor mites, the at least one strain preferably selected from the group consisting of a strain of Bacillus sp. (e.g., Bacillus paralicheniformis), a strain of Hafnia sp., (e.g., Hafnia paralvei), and a strain of Escherichia sp., (e.g., Escherichia coli).

In some embodiments, the step(s) of characterizing the one or more enriched bacteriophage strains can include optionally performing electron microscopy on the one or more bacteriophage to determine phage morphology and/or structural classification of the one or more bacteriophage.

In some embodiments, the step(s) of characterizing the one or more enriched bacteriophage strains can include selecting bacteriophage strain(s) with suitable morphology and/or structural classification, as understood by those skilled in the art.

In some embodiments, the process includes the step(s) of combining one or more of the selected bacteriophage strain(s) with a carrier or excipient.

In some embodiments, the process can include excluding from the composition any bacteriophage having a genome that comprises a toxin or virulence factor gene or an integrase gene. In some embodiments, the process can include excluding from the composition, based on the sequenced genome, one or more bacteriophage with a threshold degree of genomic/genetic relatedness to another bacteriophage (having a related tropism).

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

Some embodiments of the present disclosure can include any of the features, options, and/or possibilities set out elsewhere in the present disclosure, including in other aspects or embodiments of the present disclosure. It is also noted that each of the foregoing, following, and/or other features described herein represent a distinct embodiment of the present disclosure. Moreover, combinations of any two or more of such features represent distinct embodiments of the present disclosure. Such features or embodiments can also be combined in any suitable combination and/or order without departing from the scope of this disclosure. Thus, each of the features described herein can be combinable with any one or more other features described herein in any suitable combination and/or order. Accordingly, the present disclosure is not limited to the specific combinations of exemplary embodiments described in detail herein.

Additional features and advantages of illustrative embodiments of the present disclosure will be set forth in the description which follows, and in part will be obvious from the description, or may be learned by the practice of such illustrative embodiments. The features and advantages of such embodiments may be realized and obtained by means of the instruments and combinations particularly pointed out in the appended claims. These and other features will become more fully apparent from the following description and appended claims, or may be learned by the practice of such illustrative embodiments as set forth hereinafter.

### BRIEF DESCRIPTION OF THE DRAWINGS

In order to describe the manner in which the above recited and other advantages and features of the disclosure can be obtained, a more particular description of the disclosure briefly described above will be rendered by reference to specific embodiments thereof, which are illustrated in the appended drawings. It is appreciated that these drawings depict only typical embodiments of the disclosure and are not therefore to be considered to be limiting of its scope. The disclosure will be described and explained with additional specificity and detail through the use of the accompanying drawings in which:

FIG. 1 illustrates whole genome nucleotide comparison of bacteriophages that infect Varroa destructor mite bacteria.

### DETAILED DESCRIPTION

Before describing various embodiments of the present disclosure in detail, it is to be understood that this disclosure is not limited to the specific parameters, verbiage, and description of the particularly exemplified systems, methods, and/or products that may vary from one embodiment to the next. It is also to be understood that much, if not all of the terminology used herein is for the purpose of describing particular embodiments of the present disclosure, and is not necessarily intended to limit the scope of the disclosure in any particular manner. Thus, while certain embodiments of the present disclosure will be described in detail, with reference to specific configurations, parameters, features (e.g., ingredients, components, members, elements, parts, and/or portions), etc., the descriptions are illustrative and are not to be construed as limiting the scope of the present disclosure and/or the claimed invention. In addition, the terminology used herein is for the purpose of describing the embodiments, and is not necessarily intended to limit the scope of the present disclosure and/or the claimed invention.

### Abbreviated List of Defined Terms

To assist in understanding the scope and content of the foregoing and forthcoming written description and appended claims, a select few terms are defined directly below. Unless defined otherwise, all technical and scientific terms used herein have the same meaning as commonly understood by one of ordinary skill in the art to which the present disclosure pertains.

As used herein, the term “Varroacidal” refers to pesticidal (death-inducing or resulting in death) treatment or activity against Varroa destructor associated with a beehive and/or bees associated with the beehive. The term “Varroastatic” refers to pestistatic (growth or maturation abrogating and/or reproduction-inhibiting) treatment or activity against Varroa destructor associated with a beehive and/or bees associated with the beehive.

The terms “bacteriophage” or “phage,” as used herein, includes any prokaryotic virus, preferably lytic viruses, that infect and lyse or kill bacteria. “Bacteriophage” and “phage” are used interchangeably and can include naturally-occurring and recombinant bacteriophages, unless otherwise indicated. Reference to a phage or bacteriophage should not be construed as referring to a single, individual virus or viral entity, unless context clearly dictates otherwise. Rather, reference to a phage or bacteriophage generally includes or refers to a population, amount, or concentration of bacteriophage entities, and more particularly to a population, amount, or concentration of a bacteriophage strain or line. A “naturally-occurring” bacteriophage is a phage isolated from a natural or human-made environment that has not been modified by genetic engineering. A “recombinant bacteriophage” is a phage that comprises a genome that has been genetically modified by insertion of a heterologous nucleic acid sequence into the genome or by removal of a nucleic acid sequence from the genome. The genome of a naturally-occurring phage may be modified by recombinant DNA technology to introduce a heterologous nucleic acid sequence into the genome at a defined site. Additionally, or alternatively, the genome of a naturally-occurring phage may be modified by recombinant DNA technology to remove nucleic acid sequences that, for example, encode bacterial virulence factors (e.g., toxins). A further description of bacteriophages can be found in U.S. Pat. No. 9,617,522, the entirety of which is incorporated by reference herein.

As used herein, the term “cocktail,” “bacteriophage cocktail, “phage cocktail,” or similar is intended to be understood as a composition that includes two or more bacteriophages, and particularly, two or more strains of bacteriophage (each illustratively having a respective (cellular) tropism or specificity/infectivity that may differ in one or more respects from other bacteriophage(s) or strain(s)). The composition may have a proportional or disproportional number or concentration of phages, and the phages comprising the cocktail may have overlapping or non-overlapping tropisms. The cocktail can be in a dry form or suspended in a pharmaceutically-acceptable carrier.

The term “microbiome” may refer generally to the collective genomes of the microbiota or to the microorganisms themselves and may be used synonymously with the term microbiota. The term “microbiota” generally refers to the population, collection, and/or totality of microbes in a defined environment, habitat, or ecological community, and typically includes a plurality of genera, species, or strains of commensal, symbiotic, beneficial, and/or opportunistic pathogenic microorganisms (e.g., bacteria, archaea, fungae, protists, and/or viruses), and typically including their genetic elements (genomes). For example, as used herein, the term “microbiota” or “microbiome” is generally made with reference to the population of microbes inhabiting the Varroa destructor mite (e.g., internal to the Varroa destructor mite) and/or the (gut of the) honeybee.

The term “tropism” or “cellular tropism” is understood as the host range, number, and/or type of bacteria, that a given bacteriophage may successfully infect.

The term “narrow host range,” as used herein, particularly with respect to the tropism of a given bacteriophage, refers to the quality, characteristic, or capability of a bacteriophage to infect and kill only a specific subset of bacterial genera and/or species.

The term “probiotic” (a.k.a, “good bacteria,” “friendly bacteria, “beneficial bacteria,” etc.) refers to non-pathogenic bacterium/bacteria that provide(s) one or more health benefit(s) to the host organism in which the bacterium/bacteria lives or grows. Without being bound to any particular theory, probiotics can be internal to the organism and/or known to benefit host organisms by enhancing or augmenting food digestion and/or nutrient absorption, producing vitamins (e.g., folic acid, niacin, and vitamins B6 and B12), and/or protect against pathogenic bacteria by territorially crowding out such “bad bacteria,” producing acids or toxins that inhibit pathogenic bacterial growth, and/or stimulating the host immune system to fight off the pathogenic bacteria.

The terms “sequence identity” or “identity” refers to a specified percentage of residues in two nucleic acid or amino acid sequences that are identical when aligned for maximum correspondence over a specified comparison window, as measured by sequence comparison algorithms or by visual inspection. When sequences differ in conservative substitutions, the percent sequence identity may be adjusted upwards to correct for the conservative nature of the substitution. Sequences that differ by such conservative substitutions are said to have “sequence similarity” or “similarity.” Means for making this adjustment are well known to those of skill in the art. Typically this involves scoring a conservative substitution as a partial rather than a full mismatch, thereby increasing the percentage sequence identity.

Various aspects of the present disclosure, including systems, methods, and/or products may be illustrated with reference to one or more embodiments, which are exemplary or illustrative in nature. As used herein, the term “embodiment” means “serving as an example, instance, or illustration,” and should not necessarily be construed as preferred or advantageous over other aspects disclosed herein. In addition, reference to an embodiment is intended to provide an illustrative example without limiting the scope of the invention, which is indicated by the appended claims rather than by the description thereof. The terms “exemplary,” “illustrative,” and so forth can be used interchangeably and/or to make reference to one or more embodiments.

The term “comprising” is synonymous with “including,” “having,” “containing,” or “characterized by.” These terms are inclusive and open-ended and do not exclude additional, unrecited elements or method steps. Similarly, the terms “including,” “having,” “involving,” “containing,” “characterized by,” variants thereof (e.g., “includes,” “has,” and “involves,” “contains,” etc.), and similar terms as used herein, including the claims, shall be inclusive and/or open-ended, shall have the same meaning as the word “comprising” and variants thereof (e.g., “comprise” and “comprises”), and do not exclude additional, un-recited elements or method steps, illustratively. The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole. The phrase “consisting essentially of” limits the scope of a claim to the specified materials or steps, plus those that do not materially affect the basic and novel characteristic(s) of the claimed subject matter. The terms “comprising”, “consisting of”, and “consisting essentially of” can be alternatively used. When one of these three terms is used, the presently disclosed and claimed subject matter can include the use of either of the other two terms.

The words “can” and “may” are used in a permissive sense (i.e., meaning having the potential to), rather than the mandatory sense (i.e., meaning must).

As used in this specification and the appended claims, the singular forms “a,” “an” and “the” each contemplate, include, and specifically disclose both the singular and plural referents, unless the context clearly dictates otherwise. For example, reference to a “fertilizer” contemplates and specifically discloses one, as well as two or more fertilizers. Similarly, use of a plural referent does not necessarily require a plurality of such referents, but contemplates, includes, and specifically discloses one, as well as two or more of such referents, unless the context clearly dictates otherwise.

The terms “plurality” and “at least two” are used interchangeably.

As used herein, the term “about” or “approximately,” with regard to a value, generally means or implies +/−10% of the stated value or amount represented thereby. Moreover, throughout the present disclosure, the term “about” is used in connection with a percent concentration or composition of a component or ingredient. In such instance, the term “about” or “approximately” and/or the term “+/−10%” implies and/or includes +/−10% of the stated numeric value, as opposed to +/−10 percentage points of the recited percent. By way of example, where 20% w/w of a component or ingredient reflects 20 g of the component or ingredient per 100 mL of total mixture, the term “about” and/or the term “+/−10%” implies and/or includes a recited range from 18 g to 22 g (i.e., from 18% w/w to 22% w/w), not a range of 10% w/w to 30% w/w. Alternatives for so-called “about” values and/or +/−10% include +/−1%, +/−2%, +/−3%, +/−4%, +/−5%, +/−6%, +/−7%, +/−8%, or +/−9% of the stated value, each of which is contemplated as a suitable alternative to or substitute for the term “about” or the use of +/−10% herein.

Unless otherwise indicated, numbers expressing quantities, constituents, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

For the sake of brevity, the present disclosure may recite a list or range of numerical values. It will also be appreciated that where two or more values, or a range of values (e.g., less than, greater than, at least, and/or up to a certain value, and/or between two recited values) is disclosed or recited, any specific value or range of values falling within the disclosed values or range of values is likewise specifically disclosed and contemplated herein. Thus, disclosure of an illustrative measurement (e.g., length, width, thickness, etc.) that is less than or equal to about 10 units or between 0 and 10 units includes, illustratively, a specific disclosure of: (i) a measurement of 9 units, 5 units, 1 units, or any other value between 0 and 10 units, including 0 units and/or 10 units; and/or (ii) a measurement between 9 units and 1 units, between 8 units and 2 units, between 6 units and 4 units, and/or any other range of values between 0 and 10 units.

As used herein, the term “substantially” represents or implies an (or any) amount close to the stated amount (e.g., that still performs a desired function or achieves a (desired, intended, or expected) result). For example, the term “substantially” may refer to an amount that is within, or less than, 10%, 5%, 1%, 0.1%, 0.01%, or other percent of a stated amount. As used herein, the term “substantially devoid” means (1) an undetectable or unquantifiable amount, (2) less than or below an amount generally considered by those skilled in the art to reflect a detectable or quantifiable amount, and/or (3) less than or below an amount generally considered by those skilled in the art to be functional or able to achieve a (desired, intended, or expected) result (e.g., less than 10%, 5%, 1%, 0.1%, 0.01%, or other percent).

Percent concentrations or compositions, as presented herein, represent values measured as a w/w percent, w/v percent, or v/v percent.

As used herein, “products” include compositions, formulations, mixtures, kits, systems, and so forth. Similarly, “methods” include processes, procedures, steps, and so forth.

In addition, various aspects or embodiments of the present disclosure can be illustrated by describing components that are mixed together. As used herein, “mixed,” “mixing,” and similar terms indicate a physical combining or combination of two or more components. In some embodiments, the physical combining or combination results in a (chemical and/or physical) reaction. Such chemical reactions can be evidenced by a change in the chemical composition, pH, or other indicator relative to the components prior to being mixed (or as expected after being mixed absent the reaction). Thus, mixing and/or mixed components can include reacting and/or reacted components in certain embodiments. Accordingly, reference to mixing or mixed components includes a reference to reacting or reacted components.

Specific language will be used herein to describe the illustrative embodiments. Nevertheless it will be understood that no limitation of the scope of the disclosure is thereby intended. Rather, it is to be understood that the language used to describe the exemplary embodiments is illustrative only and is not to be construed as limiting the scope of the disclosure (unless such language is expressly described herein as essential).

While the detailed description is separated into sections, the section headers and contents within each section are for organizational purposes only and are not intended to be self-contained descriptions and embodiments or to limit the scope of the description or the claims. Rather, the contents of each section within the detailed description are intended to be read and understood as a collective whole, where elements of one section may pertain to and/or inform other sections. Accordingly, embodiments specifically disclosed within one section may also relate to and/or serve as additional and/or alternative embodiments in another section having the same and/or similar products, methods, and/or terminology.

It should also be appreciated that any headings and subheadings used herein are for organizational purposes only and are not meant to be used to limit the scope of the description or the claims.

### Overview of Disclosed Embodiments

The (internal) microbiome of the Varroa destructor mite consists of the microscopic eukaryota, archaea, bacteria and viruses living in the Varroa destructor mite. Many of these microbes are likely required for mite health as has been demonstrated in many animals, with specific strains co-evolving optimized symbiotic properties such as nutritional aids in digestion or absorption, vitamin biosynthesis, immune modulators and even modulators of mite behavior. These specific-coevolved strains can be targeted by naturally occurring bacteriophages, or viruses that kill bacteria. Bacteriophages are often highly specific for the bacteria they infect, commonly distinguishing different strains of a single species of bacteria. The invention herein presents a method for utilizing bacteriophage specificity to target key microbes in, internal to, and/or associated with the Varroa mite, rendering them sick and/or unable to thrive and/or replicate through the disruption of key natural microbiota.

Compositions of the present disclosure can provide a targeted therapy for Varroa destructor infestation in beehives by specifically lysing and/or killing one or more strains of Bacillus sp. (e.g., Bacillus paralicheniformis), Hafnia sp. (e.g., Hafnia paralvei), and/or Escherichia sp. (e.g., Escherichia coli) found in the Varroa mite (internal) microbiome and that confer a benefit or advantage on the Varroa mite. For example, compositions disclosed herein include one or more bacteriophages that specifically target and kill Bacillus sp. (e.g., Bacillus paralicheniformis), Hafnia sp. (e.g., Hafnia paralvei), and/or Escherichia sp. (e.g., Escherichia coli) while not infecting abundant probiotics (or “good” bacteria) in the beehive (ecosystem) and, specifically, in the bee (e.g., bee gut). Unlike broad-spectrum antibiotics, which indiscriminately kill, each of the one or more bacteriophages within the disclosed compositions has a narrow tropism, killing only a specific subset of bacterial genera and/or species. This beneficially allows the reduction and/or eradication of a targeted subset of bacteria—the one or more strains of Bacillus sp. (e.g., Bacillus paralicheniformis), Hafnia sp. (e.g., Hafnia paralvei), and/or Escherichia sp. (e.g., Escherichia coli) found in the Varroa mite (internal) microbiome and that confer a benefit or advantage on the Varroa mite—while leaving unharmed other bacteria within the beehive.

Thus, the bacteriophages (or phage cocktails comprising the same) can be configured for, adapted for, or otherwise capable of targeting, infecting, and killing (e.g. lysing) a single (species or strain of) bacterium, or a plurality of closely-related (species or strains of) bacteria. Redundancy or overlap in tropism may be desirable in some aspects of the present disclosure. Variety and diversity in tropism may be desirable in some aspects of the present disclosure. For example, some Varroa mites may have an imparlance in a single species or strain of bacterium in their (internal) microbiome, while other may have an imparlance in a plurality of species or strains of bacteria in their (internal) microbiome. Different combinations or two or more bacteriophage can be selected to target the single or plurality of bacteria that may be known or determined to be an effective target for affecting Varroa mite health, reproduction, growth, maturation, etc. Moreover, in certain instances, bacteria may be adapted to or capable of mutating to escape targeting, infection, or destruction by one or more strains of bacteriophage. Accordingly, compositions according to some aspects of the present disclosure may include at least two bacteriophage have tropism for the same (species or strain of) bacterium or at least some of the same bacteria, but preferably through different (genetic or tropic) mechanisms of action.

### Illustrative Compositions, Formulations and Dosage

Illustrative compositions according to various embodiments of the present disclosure are recited in the SUMMARY section, above.

As provided above, compositions of the present disclosure includes an acceptable carrier or excipient in addition to one or more bacteriophages. As used herein, the carrier or excipient can be a biologically compatible formulation, gaseous, liquid or solid, or mixture thereof, that is suitable for one or more routes of administration, in vivo delivery, or contact. A formulation is compatible in that it does not destroy activity of an active ingredient therein (e.g., the bacteriophage or bacteriophage cocktail) or induce adverse side effects that outweigh any prophylactic or therapeutic effect or benefit.

It should be appreciated that the disclosed compositions may contain one or more carriers or excipients. Acceptable carriers and excipients (or the acceptability thereof) can be determined in part by the particular composition being administered, as well as by the particular method used to administer the composition.

Moreover, the compositions described herein may be formulated in any form suitable for the intended method of application or administration. Specifically, the carrier or excipient may be suitable for or compatible with the method of application or administration. Illustratively, in one or more embodiments, the carrier or excipient can be or comprise (i) one or more liquid components (e.g., suitable for liquid applications, spraying, misting, etc. or in a feeding liquid or drinking water), (ii) one or more aerosol components (e.g., suitable for aerosol applications, ultralow volume fogger application, surface acoustic wave nebulization, etc.), and/or (iii) one or more solid (or semi-solid) components (e.g., suitable for solid applications, dusting, powder disbursement, etc. or in a feed component). For example, in some embodiments, liquid colloids, aqueous or oil suspensions, non-aqueous solutions, dispersible powders or granules (including micronized particles or nanoparticles), emulsions, or syrups may be prepared.

In at least one embodiment, the carrier or excipient cam be or comprise lactose and/or leucine.

In at least one embodiment, the composition may be formulated as solution or suspension comprising one or more bacteriophage in admixture with at least one excipient suitable for the manufacture of a solution or suspension of the one or more bacteriophage. Such a solution or suspension can be applied or administered by any suitable means know in the art.

In yet another embodiment, compositions may be formulated as dispersible powders and granules suitable for preparation of a suspension by the addition of suitable excipients. Such dispersible powders and granules can be applied or administered by any suitable means know in the art.

Illustratively, the carrier or excipient can comprise a buffer or buffering agent (in water). Illustratively, the carrier or excipient can comprise a buffered solution (e.g., buffering agent(s) in water). Buffering agents can be suitable for buffering the composition (in liquid/water) at any suitable pH (e.g., greater than, less than, equal to, between, and/or about pH 6.5, 6.6, 6.7, 6.8, 6.9, 7.0, 7.1, 72, 7.3, 7.4, 7.5, 7.6, 0.7.7, 7.8, 7.9, 8.0, 8.1, 8.2, 8.3, 8.4, or 8.5).

Illustratively, the buffering agent can be or comprise a sodium phosphate buffer (in water). In some embodiments, the buffer can be or comprise (greater than or equal to) about 25 mM, 50 mM, 100 mM 150 mM, or 200 mM sodium phosphate buffer (pH 7.0-7.9). In some embodiments, the buffer or buffering agent can be or comprise (greater than or equal to) about 50 mM sodium phosphate buffer (pH ˜7.4).

In at least one embodiment, the carrier or excipient can be or compose SM buffer (in water), as known in the art.

Illustratively, the carrier or excipient can comprise one or more salts. In some embodiments, the salt(s) can be or comprise NaCl (or CaCl, MgCl, KCl), or corresponding or other anion/cation salt combination, as known in the art and suitable for bee/beehive applications. In some embodiments, the salt(s) (e.g., NaCl) can be included in the composition (or carrier or excipient thereof) at a concentration of greater than, less than, equal to, between, and/or about 1 g/L, 2 g/L, 3 g/L, 4 g/L, 4.5 g/L, 5 g/L, 5.1 g/L, 5.2 g/L, 5.3 g/L, 5.4 g/L, 5.5 g/L, 5.6 g/L, 5.7 g/L, g/L, 5.9 g/L, 6.0 g/L, 6.5 g/L, 7 g/L, etc. or greater than, less than, equal to, between, and/or about 50 mM, 60 mM, 70 mM, 75 mM, 80 mM, 85 mM, 90 mM, 95 mM, 100 mM, 105 mM, 110 mM, 115 mM, 120 mM, 125 mM, 130 mM, 140 mM, 150 mM, etc. In some embodiments, the salt can be or comprise (greater than or equal to) about 5.8 g/L NaCl (or (greater than or equal to) about 100 mM).

Alternatively, or in addition, the salt can be or comprise MgSO4 (e.g., MgSO4·7H2O) or a corresponding or other anion/cation salt combination, as known in the art and suitable for bee/beehive applications. In some embodiments, the salt(s) (e.g., NaCl) can be included in the composition (or carrier or excipient thereof) at a concentration of greater than, less than, equal to, between, and/or about 0.1 g/L, 0.25 g/L, 0.5 g/L, 1 g/L, 1.1 g/L, 1.2 g/L, 1.3 g/L, 1.4 g/L, 1.5 g/L, 1.6 g/L, 1.7 g/L, 1.8 g/L, 1.9 g/L, 2.0 g/L, 2.1 g/L, 2.2 g/L, 2.3 g/L, 2.4 g/L, 2.5 g/L, 2.6 g/L, 2.7 g/L, 2.8 g/L, 2.9 g/L, 3.0 g/L, 3.5 g/L, 4 g/L, etc., or greater than, less than, equal to, between, and/or about 0.5 mM, 1 mM, 2 mM, 3 mM, 4 mM, 5 mM, 6 mM, 7 mM, 7.5 mM, 8 mM, 8.5 mM, 9 mM, 11 mM, 12 mM, 13 mM, 14 mM, 15 mM, etc. In some embodiments, the salt can be or comprise (greater than or equal to) about 2 g/L MgSO4·7H2O (or (greater than or equal to) about 8 mM).

Illustratively, the carrier or excipient can comprise one or more peptides.

Illustratively, the carrier or excipient can comprise a yeast extract.

Illustratively, the carrier or excipient can be or comprise greater than or equal to about 50 mM sodium phosphate buffer (pH 7.4), 5.8 g/L NaCL (100 mM final), 2 g/L MgSO4·7H2O (8 mM final).

Additional or alternative excipients suitable for use in connection with suspensions include suspending agents, such as sodium carboxymethylcellulose, methylcellulose, hydroxypropyl methylcellulose, sodium alginate, polyvinylpyrrolidone, gum tragacanth, gum acacia, dispersing, or wetting agents such as a naturally occurring phosphatide (e.g., lecithin), a condensation product of an alkylene oxide with a fatty acid (e.g., polyoxyethylene stearate), a condensation product of ethylene oxide with a long chain aliphatic alcohol (e.g., heptadecaethyleneoxycethanol), a condensation product of ethylene oxide with a partial ester derived from a fatty acid and a hexitol anhydride (e.g., polyoxyethylene sorbitan monooleate); polysaccharides and polysaccharide-like compounds (e.g., dextran sulfate); glycoaminoglycans and glycosaminoglycan-like compounds (e.g., hyaluronic acid); and thickening agents, such as carbomer, beeswax, hard paraffin, or cetyl alcohol. The suspensions may also contain one or more preservatives such as acetic acid, methyl and/or n-propyl p-hydroxy-benzoate; one or more coloring agents; one or more flavoring agents; and one or more sweetening agents such as sucrose or saccharin.

The compositions may also be in the form of oil-in water emulsions. The oily phase may be a vegetable oil, such as olive oil or arachis oil, a mineral oil, such as liquid paraffin, or a mixture of these. Suitable emulsifying agents include naturally-occurring gums, such as gum acacia and gum tragacanth; naturally occurring phosphatides, such as soybean lecithin, esters, or partial esters derived from fatty acids; hexitol anhydrides, such as sorbitan monooleate; and condensation products of these partial esters with ethylene oxide, such as polyoxyethylene sorbitan monooleate. The emulsion may also contain sweetening and flavoring agents. Syrups and elixirs may be formulated with sweetening agents, such as glycerol, sorbitol, or sucrose. Such formulations may also contain a demulcent, a preservative, a flavoring, or a coloring agent.

Cosolvents and adjuvants may be added to the formulation. Non-limiting examples of cosolvents contain hydroxyl groups or other polar groups, for example, alcohols, such as isopropyl alcohol; glycols, such as propylene glycol, polyethyleneglycol, polypropylene glycol, glycol ether; glycerol; polyoxyethylene alcohols and polyoxyethylene fatty acid esters. Adjuvants include, for example, surfactants such as, soya lecithin and oleic acid; sorbitan esters such as sorbitan trioleate; and polyvinylpyrrolidone.

Accordingly, there exists a wide variety of suitable formulations of pharmaceutical compositions (see, e.g., Remington's Pharmaceutical Sciences, incorporated herein by reference). Suitable excipients may be or include carrier molecules and can include antioxidants such as ascorbic acid; chelating agents such as EDTA; carbohydrates such as dextrin, hydroxyalkylcellulose, hydroxyalkylmethylcellulose, and stearic acid; liquids such as oils, water, saline, glycerol and ethanol; wetting or emulsifying agents; pH buffering substances; and the like. Liposomes are also included within the definition of pharmaceutically acceptable excipients. Additional or alternative examples of carriers include silicon dioxide (silica, silica gel), carbohydrates or carbohydrate polymers (polysaccharides), cyclodextrins, starches, degraded starches (starch hydrolysates), chemically or physically modified starches, modified celluloses, gum arabic, ghatti gum, tragacanth, karaya, carrageenan, guar gum, locust bean gum, alginates, pectin, inulin or xanthan gum, or hydrolysates of maltodextrins. In various embodiments, the bacteriophage can be dispersed throughout the carrier.

The compositions of the present disclosure further comprise (an amount of) one or more bacteriophage described/disclosed herein. It should be appreciated that the compositions and/or formulations disclosed herein contain a total amount of one or more bacteriophages (collectively or individually) sufficient to achieve the intended result/effect.

The compositions may, for convenience, be prepared or provided as a unit dosage form and can be packaged in unit dosage forms for ease of administration and uniformity of dosage. A “unit dosage form” as used herein refers to a physically discrete unit suited as unitary dosages for the subject to be treated. Each unit containing a predetermined quantity of the one or more bacteriophage optionally in association with a pharmaceutically-acceptable carrier (e.g., excipient, diluent, vehicle or filling agent) which, when administered in one or more doses, is calculated to produce the desired effect. Unit dosage forms can contain a daily or weekly dose or unit, daily or weekly sub-dose, or an appropriate fraction thereof, of an administered compound. A sterile liquid carrier, for example, can be added prior to administration or delivery in vivo. Unit dosage forms additionally include, for example, ampules and vials with liquid compositions disposed therein. The individual unit dosage forms can be included in multi-dose kits or containers.

A dosage (or administration) of the composition can one or more doses. A dose of the composition can include, for example, greater than or equal to 1×10⁴ PFU/mL or PFU/mg of composition of one or more bacteriophage, in accordance with one or more aspects or embodiments of the present disclosure. Alternative doses can include greater than or equal to 1×10⁵, 1×10⁶, 1×10⁷, 1×10⁸, 1×10⁹, 1×10¹⁰, 1×10¹¹, 1×10¹² or more PFU/mL or PFU/mg. Suitable dosage size or amounts can range from 1 μL to 1000 mL or more (e.g., of fluid or semi-solid composition), 1 μg to 5000 mg or more (e.g., of solid or semi-solid composition), or other amount as known in the art.

The disclosed compositions can be administered in accordance with the methods at any frequency as a single bolus or multiple dose e.g., one, two, three, four, five, or more times daily, weekly, or monthly, and/or for as long as appropriate. Exemplary frequencies are typically from 1-3 times, 2-times or once, daily or weekly; for example, once per week or twice per week for 1, 2, 3, 4, 5, 6, 7, 8, 9, 10, 11, or 12 months of the year. Timing of administration can be dictated by the desired effect. The skilled artisan will appreciate the factors that may influence the dosage, frequency, and timing required to provide an amount sufficient or effective for providing the desired effect or benefit. Dosage and administration can be adjusted to provide sufficient levels of the one or more bacteriophage (collectively or individually) or to maintain the desired effect.

In at least one embodiment, the composition can be administered or received as part of a treatment protocol. The treatment protocol can include a first treatment period (or phase). The first treatment phase can include a first dosage of the composition, administered or received in accordance with a first dosage schedule. The first dosage schedule can be, for example, a daily dosage schedule or any other suitable dosage schedule (e.g., twice daily, every other day, once weekly, twice weekly, etc.). The first dosage can include any suitable dose (amount) disclosed herein. In at least one embodiment, the first dose (amount) of the first dosage in the first treatment phase can be or include a (relatively high) initial treatment dose (e.g., greater than or equal to 1×10⁶, 1×10⁷, 1×10⁸, 1×10⁹, or 1×10¹⁰ PFU/mL or PFU/mg, or more). In some embodiments, the first dosage phase (or schedule thereof) can be or last for any suitable amount of time (e.g., greater than or equal to 1 week, 2 weeks, 3 weeks, 4 weeks, 1 month, 2 months, 3 months, 6 months, 9 months, 1 year, etc.).

In some embodiments, the treatment protocol can include a second treatment period (or phase). The second treatment phase can include a second dosage of the composition, administered or received in accordance with a second dosage schedule. The second dosage schedule can be, for example, a weekly dosage schedule or any other suitable dosage schedule (e.g., daily, every other day, twice weekly, etc.). The second dosage can include any suitable dose (amount) disclosed herein. In at least one embodiment, the second treatment phase can include a (lower) maintenance treatment dose (e.g., greater than or equal to 1×10⁴, 1×10⁵, 1×10⁶, 1×10⁷, or 1×10⁸ PFU/mL or PFU/mg. Illustratively, the second dosage can include a lower concentration of phage that the first dosage. Alternatively, or in addition, the second treatment phase can include a less frequent dosage schedule than the first treatment phase. In some embodiments, the second dosage phase (or schedule thereof) can be or last for any suitable amount of time (e.g., greater than or equal to 3 months, 6 months, 9 months, 1 year, 2 years, 3 years, etc., or indefinitely).

In some embodiments, a composition containing one or more bacteriophages is co-administered with a probiotic and/or prebiotic. Embodiments of the present disclosure can include kits that include one or more of the inventive compositions, optionally with one or more probiotic and/or prebiotic compositions, as will be apparent to those skilled in the art.

As used herein, “co-administration” means concurrently or administering one substance followed by beginning the administration of a second substance within 24 hours, 20 hours, 16 hours, 12 hours, 8 hours, 4 hours, 1 hour, 30 minutes, 15 minutes, 5 minutes, 1 minute, a range bounded by any two of the aforementioned numbers, and/or about any of the aforementioned numbers. In some embodiments, co-administration is concurrent administration.

In some embodiments, the bacteriophage-based product may be delivered to the beehive once or twice a week by several delivery methods including ultralow volume fogging or surface acoustic wave nebulization of a liquid or other suitable sample form, or delivery of a lyophilized power, or a solid liquid substance into the beehive, which delivers the bacteriophages through a combination of bee movement and/or evaporation throughout the hive. The bacteriophage compositions may be delivered alone or in combination with a probiotic aimed at improving hive health.

### Processes and Methods for Making and Administering Compositions

Embodiments of the present disclosure additionally include processes for making the compositions disclosed herein and methods for administering said compositions to the beehive and/or bees.

An exemplary process for preparing the bacteriophage component of compositions disclosed herein, includes isolating the bacteriophage (from an environmental source) and characterizing the bacteriophage.

In general, “characterizing” the bacteriophage can include measuring its lytic activity to ensure that the bacteriophage is a lytic phage and not a lysogenic phage, measuring the host range to ensure the phage has a narrow tropism that includes a desired bacterial target, optionally passing it through Varroa mites to ensure that the bacteriophage survives conditions of or internal to the Varroa mite, and/or sequencing the bacteriophage genome to ensure that the phage is not harboring any bacterial toxin or virulence factor or integrase gene, which may indicate that the phage can be lysogenic. During the characterizing process, any bacteriophage that fails any one criterion is excluded from further consideration.

In some embodiments, genomic sequencing of the bacteriophage is performed to determine how closely related each of the various phages are, particularly when those phages are tropic for the same bacterium. This additional, sometimes optional step, can beneficially allow for the selection and combination of phages that are as unrelated to each other as possible and to decrease the likelihood that the targeted bacteria can develop resistance against the selected phages. Thus, after identifying and characterizing a first bacteriophage, additional phages specific for each target bacterium can be included that are each validated as lytic, having a narrow and specific tropism, able to survive conditions in or internal to the Varroa mite, and unlikely to promote bacterial escape mutants resistant to the cocktail of phages.

Following isolation and characterization, the selected bacteriophage is prepared in any manner to be incorporated as a composition for administration to the beehive.

As discussed above, the compositions disclosed herein can be administered alone or co-administered with a probiotic. The administration dosage and schedule can be determined based on the desired effect and as known in the art.

In general, the method/process steps described herein can follow or include one or more of the following: (1) collecting environment sample(s); (2) setting up enrichment culture; (3) isolating phage from the enrichment culture; (4) purifying the phage; (5) phage titer test to high concentration; (6) characterizing the phage (e.g., using electron microscope and/or genomic DNA isolation and sequencing); (7) optionally performing a restriction enzyme assay/analysis; (8) performing a lytic activity assay; (9) optionally preparing a phage frozen stock; (10) optionally combining two or more strains of selected/suitable bacteriophage strains; (11) testing safety and efficacy of the bacteriophage (or mixture of bacteriophages); and so forth. In a more general sense, the methodology can involve: isolating and characterizing key (internal) bacteria from the Varroa destructor mite and targeting those not known to be beneficial to healthy honey bees; isolating and characterizing bacteriophages that infect these bacterial hosts; and testing safety and efficacy of the bacteriophages. Various illustrative and specific details of the foregoing are provided, below.

### ILLUSTRATIVE EXAMPLES

### Example 1: Varroa destructor Microbiota Isolation

Varroa destructor microbiota were isolated directly from environmental samples of Varroa destructor mite. Live mite-infested bees were used to harvest mites by placing bees in a jar having a wire mesh covering with a few tablespoons powdered sugar, rolling the bees in the sugar to induce release of the mites and then retrieving the free mites. Mites were then added to a sealed jar with chloroform, subjected to UV light for sterilization of their surface, and homogenized by sterile mortar and pestle. Sterile LB media was immediately used to solubilize homogenate, which was spread on selective plates (Cetrimide and MacConkey).

Cultures were allowed to incubate at 30° C. or 37° C. for 24-48 hours. Strains were sequenced using 16S RNA gene primers and standard PCR followed by Sanger sequencing for identification. From the colonies that arose on the plates, three bacteria were further targeted because they were not reported in published studies on the key conserved, beneficial bacteria in the honey bee microbiome, namely several species of Lactobacillus, and Bifidobacterium, Snodgrassella alvi, Gilliamella apicola. Frischella perrara, Bartonella apis and Commensalibacter spp. Moreover, Apibacter, Parasccharibacter, Fructobacillus, Lactobacillus, and Saccharibacter are also often reported at various levels (reviewed in Zheng et al. Lab Anim., 2018). However, even if the bacteria species chosen are found in honey bee, the strains found in the honey bee and mite are likely distinct due to coevolution with the phylogenetically distinct hosts. Isolated genomic DNA of these three strains was then submitted for Illumina iSeq sequencing and their partial genomic sequences were aligned to close relatives in Geneious version 8.0.5, and further analyzed (Table 1). These three bacteria include an unknown Bacillus sp. strain that is most likely Bacillus paralicheniformis (Bacillus sp. strain VdestructorMite01), an Escherichia coli strain (Escherichia coli strain VdestructorMite02), and a Hafnia sp. that is most likely a paralvei strain (Hafnia paralvei strain VdestructorMite03). Bacillus sp. strain VdestructorMite01 aligned 98.7% to Bacillus paralicheniformis (CP010524.1). Its 16S rRNA had homology (>99% identity) to both B. licheniformis and B. paralicheniformis strains. It was therefore further characterized by analysis of its Fengycin gene FenC as well as its LanM gene which displayed 95% and 100% identity, respectively, to B. paralicheniformis, making the likely species B. paralicheniformis. Escherichia coli strain VdestructorMite02 was aligned 99.9% with E. coli CP053607.1. Its 16S rRNA had homology (>99% identity) to both E. coli and Salmonella strains, however a BLASTN of the assembled consensus sequence yielded E. coli strains as the 50 top hits. In addition, PrmD was used to distinguish between Salmonella and E. coli as previously reported by Winfield and Groisman (PNAS, 2004), with the PrmD gene having 100% identity to PrmD from E. coli (AY725419). Hafnia paralvei strain VdestructorMite03 aligned 96.25% with H. paralvei (CP014031.2) and displayed >99% 16S rRNA identity with both H. alvei and H. paralvei. However BLASTN of the partial genome displayed >99% identity to H. paralvei strains and only ˜84% identity to H. alvei strains. In addition, Hafnia paralvei strain VdestructorMite03 did not encode the Mdch gene for malonate utilization found in H. alvei strains (Guys et al, Int J Syst Evol Microbiol. 2010, Shannon et al, J Clin Microbiol. 2011). Thus this strain is likely Hafnia paralvei. All three bacteria also grow well on Luria broth (LB) for mass production.

Without being bound to any particular theory, the genomic/genetic difference between the Bacillus sp. strain(s) and the Hafnia sp. strains isolated from the Varroa mite and known strains of Bacillus sp. strain(s) and the Hafnia sp. is understandable, given the unique form of life represented by the Varroa mite.

TABLE 1
Basic genomic properties of bacteria isolated from Varroa destructor mite.

| Bacteria | Assembled to | Coverage | 16S BLASTN | Properties |
|---|---|---|---|---|
| Bacillus sp | B. paralicheniformis | 4,463,729 | NR_137421.1(100%) | FenC⁺, |
| strain | (CP010524.1) | (98.7%) | | LanM(100%) |
| Escherichia coli | E. coli | 4,814,360 | NR_112558.1 (99.91%) | PmrD(100%) |
| strain | (CP053607.1) | (99.9%) | | |
| Hafnia paralvei | H. paralvei | 4,606,768 | NR_116898.1(99.7%) | Mdch⁻ |
| strain | (CP014031.2) | (96.2%) | NR_044729(99.5%) | |

### Example 2: Isolation and Basic Characterization of Bacteriophage Specific for Varroa Mite Bacteria

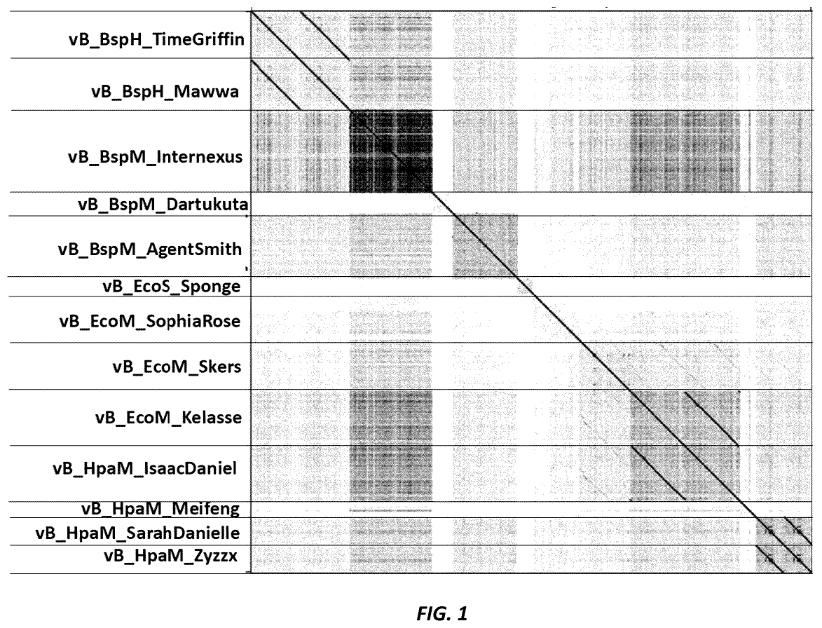

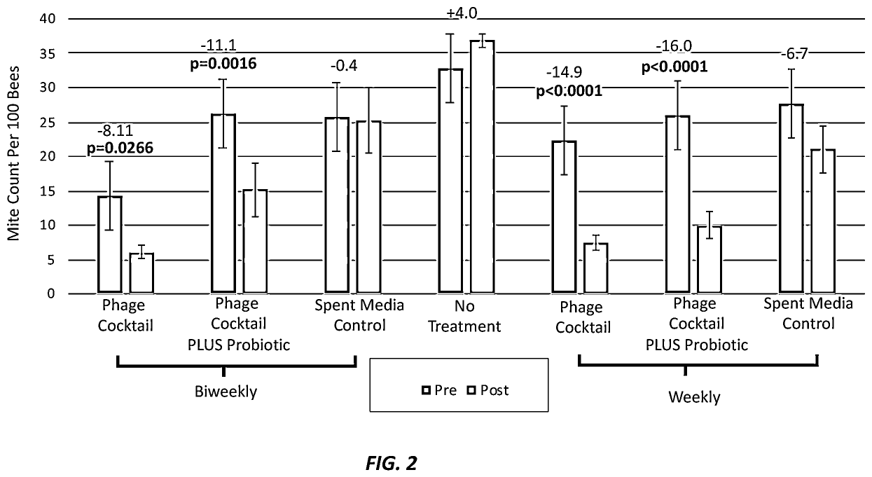

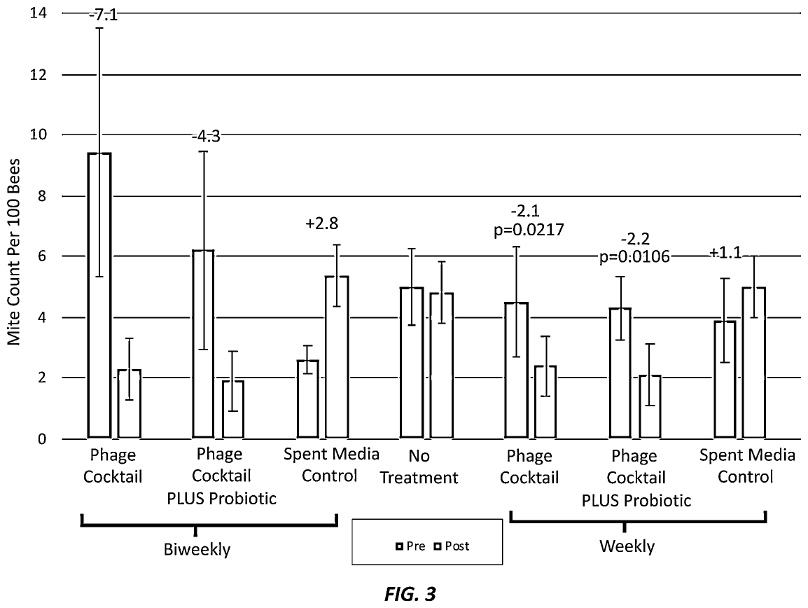

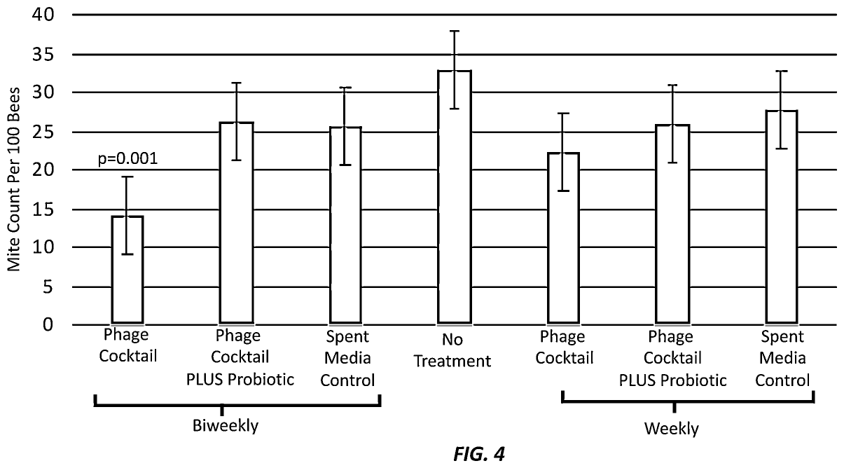

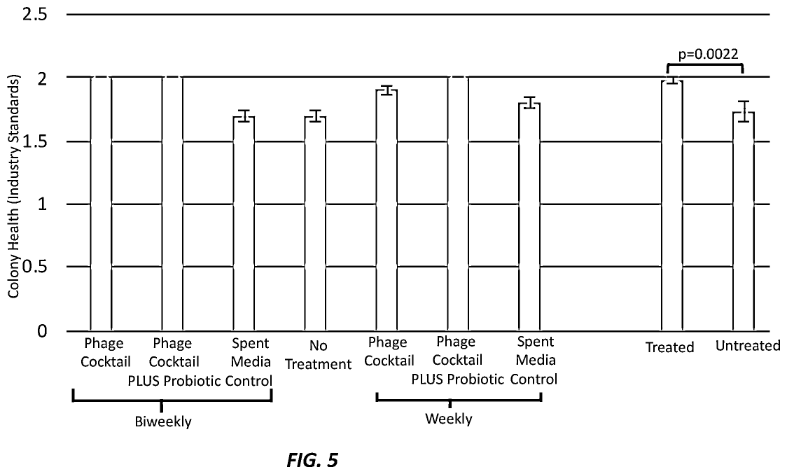

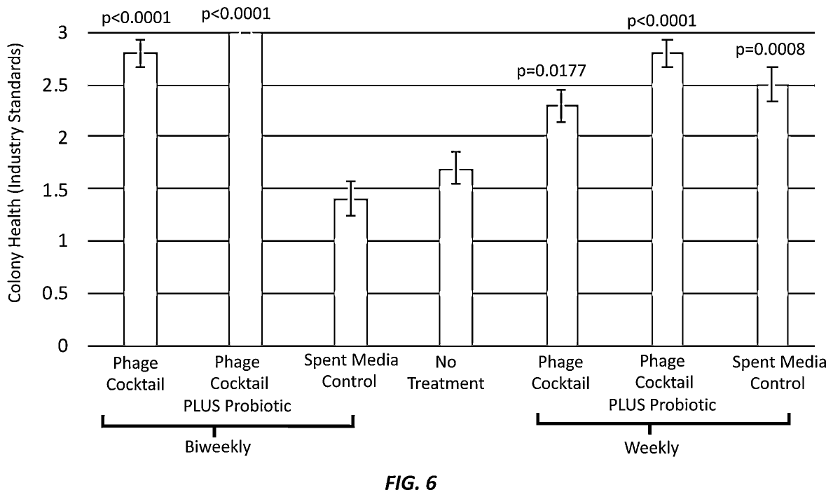

Bacteriophages were isolated from raw sewage through the addition of raw sewage to overnight cultures of each of the three bacterial strains (Varroa destructor mite Bacillus sp. strain VdestructorMite01, E. coli strain VdestructorMite02, and H. paralvei strain VdestructorMite03, along with fresh media. Cultures are allowed to incubate at 30° C. or 37° C. either aerobically or anaerobically for at least 24 hours, and then plated for plaques. Plaques are isolated three times by picking followed by reinfection of host bacteria. The thirteen final bacteriophage candidates are fully sequenced as well as tested for strain specificity against the other bacteria isolated from (inside) the Varroa mite. No cross-reactivity was seen. In addition, all bacteriophages appeared lytic through plaque morphology analysis. The basic characteristics of the bacteriophages are summarized in Table 2 and FIG. 1. The bacteriophages isolated against the specific Varroa destructor mite bacteria were named according to standard nomenclature, with vB indicating they are viruses of bacteria, following an underscore the bacterial species and phage morphology are provided (ie, BspH is Bacillus sp. and Herelleviridae), followed by an underscore and the common name of the phage (ie TimeGriffin). The bacteriophages fall into nine groups of related phages. The first group contains Bacillus phages vB BspH TimeGriffin and vB BspH Mawwa which are approximately 94% identical, the second harbors Escherichia and Hafnia phages Skers, Kelasse, and IsaacDaniel, all T4-like phages. IsaacDaniel and Kelasse display 96.12% identity and Skers is 83.51% and 83.6% identical to IsaacDaniel and Kelasse, respectively. The final group consists of Hafnia phages SarahDanielle and Zyzzx (90.83% identical). All other phages are not closely related, and three do not currently have any close relatives in the NCBI database GenBank.

TABLE 2
Basic characteristics of bacteriophages that infect Varroa destructor
mite bacteria (strains VdestructorMite01- VdestructorMite03).

| | | | Genomic | |
|---|---|---|---|---|
| | SEQ | | size | General |
| Bacteriophage | ID # | Bacterial host | (bp) | Phylogeny |
| vB_BspH_TimeGriffin | 4 | Bacillus sp strain | 148,525 | Lytic Bastille-like |
| | | VdestructorMite01 | | |
| vB_BspH_Mawwa | 1 | Bacillus sp strain | 149,014 | Lytic Bastille-like |
| | | VdestructorMite01 | | |
| vB_BspM_Internexus | 2 | Bacillus sp strain | 252,262 | Lytic AR9-like |
| | | VdestructorMite01 | | |
| vB_BspM_Dartukuta | 5 | Bacillus sp strain | 60,862 | No close relative |
| | | VdestructorMite01 | | |
| vB_BspM_AgentSmith | 3 | Bacillus sp strain | 200,223 | No close relative |
| | | VdestructorMite01 | | |
| vB_EcoS_Sponge | 13 | Escherichia coli strain | 44,887 | Lytic SO-1-like |
| | | VdestructorMite02 | | |
| vB_EcoM_SophiaRose | 10 | Escherichia coli strain | 139,943 | Lytic Rv5-like |
| | | VdestructorMite02 | | |
| vB_EcoM_Skers | 11 | Escherichia coli strain | 154,769 | Lytic T4-like |
| | | VdestructorMite02 | | |
| vB_EcoM_Kelasse | 12 | Escherichia coli strain | 167,034 | Lytic T4-like |
| | | VdestructorMite02 | | |
| vB_HpaM_IsaacDaniel | 9 | Hafnia paralvei strain | 167,265 | Lytic T4-like |
| | | VdestructorMite03 | | |
| vB_HpaM_Meifeng | 7 | Hafnia paralvei strain | 48,503 | No close relative |
| | | VdestructorMite03 | | |
| vB_HpaM_SarahDanielle | 8 | Hafnia paralvei strain | 86,185 | Lytic FelixO1-like |
| | | VdestructorMite03 | | |
| vB_HpaM_Zyzzx | 6 | Hafnia paralvei strain | 85,869 | Lytic FelixO1-like |
| | | VdestructorMite03 | | |

“bp” stands for base pair.

FIG. 1 illustrates the results of whole genome nucleotide comparison of bacteriophages that infect Varroa destructor mite bacteria using Gepard (Krumsiek et al., Bioinformatics, 2007) dot plot analysis. Diagonal lines indicated nucleotide identity.

### Example 3: Bacteriophage Efficacy Testing

Without being bound to any particular theory, Varroa destructor mites are typically seasonal, replicating at a higher rate in drone brood in the summer, and peaking in concentration in the fall (peak mite season in most areas of the United States). Administration of an illustrative phage cocktail directed against Bacillus sp. (e.g., Bacillus paralicheniformis), Hafnia sp. (e.g., Hafnia paralvei) and Escherichia sp. (e.g., Escherichia coli) in the Varroa destructor associated with beehives is effective in field trials, decreasing mite counts up to six-fold during peak mite season in the fall (FIG. 2). Although mite differences are more difficult to determine during the early summer due to low mite levels, administration of an illustrative phage cocktail decreased mite counts ˜2-fold early season in the summer (FIG. 3). Additionally, the effects of this early season treatment could be seen months later. Administration of the illustrative phage cocktail against Bacillus sp. (e.g., Bacillus paralicheniformis), Hafnia sp. (e.g., Hafnia paralvei) and Escherichia sp. (e.g., Escherichia coli) in, internal to, and/or associated with Varroa destructor that is associated with the beehive and/or with bees associated with the beehive in June 15-July 6 reduced mite counts two months after the first treatment (˜1.5 months after the final treatment on July 6^{th}) (FIG. 4).

FIG. 2 presents the results of field trials in which an illustrative phage cocktail directed against Bacillus sp. (e.g., Bacillus paralicheniformis), Hafnia sp. (e.g., Hafnia paralvei) and Escherichia sp. (e.g., Escherichia coli) in the Varroa destructor associated with beehives decreased mite counts in the hives by −6-fold when compared with untreated hives during peak mite season. Mite counts are per 100 bees and is based off of the sugar roll mite count. Both pre- and post-treatment counts are provided. Changes in mite counts are shown above the graphs along with p-values that are below 0.05. Difference in pre and post mite counts were analyzed by ANOVA with post hoc Dunnett's using untreated hives as the control with JMP version 14 SAS Institute Inc., Cary, NC. Hives were treated once a week or twice a week (biweekly) for three weeks in early season (Jun. 15-Jul. 6, 2020), and then again in peak mite season Aug. 28-Sep. 18, 2020. Mite counts are pre-treatment (day 0) and post-treatment 3 days after the final treatment for biweekly or 1 week after the final treatment for weekly (day 21).

FIG. 3 presents the results of field trials in which an illustrative phage cocktail directed against Bacillus sp. (e.g., Bacillus paralicheniformis), Hafnia sp. (e.g., Hafnia paralvei) and Escherichia sp. (e.g., Escherichia coli) in the Varroa destructor associated with beehives decreased mite counts in the hives by −2-fold when comparing hives pre- and post-treatment during early season. Mite counts are per 100 bees and is based off of the sugar roll mite count. Both pre- and post-treatment counts are provided. Changes in mite counts are shown above the graphs along with p-values that are below 0.05. Due to low mite counts and variability between hives early season, data was analyzed by ANOVA comparing the pre and post result within each single treatment group with JMP version 14 SAS Institute Inc., Cary, NC. Hives were treated once a week or twice a week (biweekly) for three weeks in early season (Jun. 15-Jul. 6, 2020). Mite counts are pre-treatment (day 0) and post-treatment 3 days after the final treatment for biweekly or 1 week after the final treatment for weekly (day 21).

FIG. 4 presents the results of field trials in which an illustrative phage cocktail directed against Bacillus sp. (e.g., Bacillus paralicheniformis), Hafnia sp. (e.g., Hafnia paralvei) and Escherichia sp. (e.g., Escherichia coli) in the Varroa destructor associated with beehives caused mite counts to remain reduced ten weeks after the first preseason phage treatment. Mite counts are per 100 bees and is based off of the sugar roll mite count. The post-treatment data presented in FIG. 4 was analyzed by ANOVA with post hoc Dunnett's using untreated hives as the control with JMP version 14 SAS Institute Inc., Cary, NC. Hives were treated once a week or twice a week (Biweekly) for three weeks in early season (Jun. 15-Jul. 6, 2020), and mites were assessed August 28.

It is noted that any statistically-significant decrease in mite counts can be sufficient to support the health, vitality, and/or longevity of the beehive and/or bees, preserving the beehive and/or bees and prevent colony collapse. Indeed, even a modest decreases in mite counts, can be sufficient to support the health, vitality, and/or longevity of the beehive and/or bees, preserving the beehive and/or bees and prevent colony collapse. In some cases, even abrogating the growth/expansion, reproduction, and/or health/wellness of Varroa destructor associated with the beehive and/or bees can be sufficient to support the health, vitality, and/or longevity of the beehive and/or bees, preserving the beehive and/or bees and prevent colony collapse.

### Example 4: Safety Testing

In addition to being effective at reducing Varroa destructor (population) levels, honey bee colony health remained stable or increased in field trials at peak mite season, assessed by overall bee count, bee activity, and new egg count as well as brood caping one week after the final weekly treatment (FIG. 5, in the comparison of the combined treated and untreated). These differences in colony health were even more dramatic preseason (FIG. 6). The safety and specificity observed herein is consistent with the expected differences in the microbiome of the honey bee (of the class Insecta) and the Varroa destructor mite (of the class Arachnida), two very different forms of life. The Varroa destructor mite feeds on the fat body of the honey bee, a discrete organelle separate from the honey bee digestive tract, while the honey bee feeds by foraging pollen and nectar. Even if bacteria species were targeted that were abundant in both the honey bee and the Varroa destructor mite, they would be unlikely to be the same strain, having evolved with two phylogenetically distant organisms which feed on very different material and have very different lifestyles. Microbiome studies have shown that even related organisms of the same genera usually harbor distinct microbiomes (different species and strains of bacteria) due to co-evolution of unique traits. The isolation of three bacteriophages in this study with no close homology to any bacteriophage in NCBI GenBank (namely Bacillus phages vB_BspM_Dartukuta and vB_BspM_AgentSmith, and Hafnia phage vB_Hpa_Meifeng) alludes to the unique nature of the mite microbiome.

FIG. 5 presents the results of field trials in which an illustrative phage cocktail directed against Bacillus sp. (e.g., Bacillus paralicheniformis), Hafnia sp. (e.g., Hafnia paralvei) and Escherichia sp. (e.g., Escherichia coli) in the Varroa destructor associated with beehives improved colony health during peak mite season. Hives were treated once a week or twice a week (biweekly) for three weeks in early season (Jun. 15-Jul. 6, 2020), and then again in peak mite season Aug. 28-Sep. 18, 2020. Colony health was assessed using a scale of 1-3 (3 for the healthiest) using industry standards for overall bee count, bee activity, and new egg count as well as brood caping one week after the final treatment for weekly (day 21).

FIG. 6 presents the results of field trials in which an illustrative phage cocktail directed against Bacillus sp. (e.g., Bacillus paralicheniformis), Hafnia sp. (e.g., Hafnia paralvei) and Escherichia sp. (e.g., Escherichia coli) in the Varroa destructor associated with beehives improved early season colony health. Hives were treated once a week or twice a week (biweekly) for three weeks in early season (Jun. 15-Jul. 6, 2020). Colony health was assessed using a scale of 1-3 (3 for the healthiest) using industry standards for overall bee count, bee activity, and new egg count as well as brood caping one week after the final treatment for weekly (day 21).

### Example 5: Administration of Bacteriophage

Bacteriophage preparations may be either liquid or dry. Any suitable method known in the art for applying or administering compositions of the present disclosure to bees and/or beehives may be used, particularly those which are acceptable and/or known for administration to beehive/bee pests, including but not limited to (i) combining the composition with feed and/or water, and/or (ii) applying or administering the composition as a spray, mist, aerosol (e.g., ultralow volume fogger application, surface acoustic wave nebulization, etc.), bait, trap, etc.

### Example 6: Mode of Action

The administered phage therapy may cause the Varroa destructor mite to become sick, not replicate and/or die due to lysis or death of bacteria and downstream effects within the Varroa destructor mite. These effects may include but are not limited to decreased digestive capacity of the mite due to contributions of the beneficial bacteria to digestion, decreased production of a vitamin or other essential nutrient, decreased antimicrobial activity of the targeted bacteria, or even increased antimicrobial activity due to bacterial cell lysis and the corresponding release of antimicrobials or stimulation of the immune system. Bacillus and Hafnia species from other organisms have been reported to contribute antimicrobial activity in several studies.

The administered phage therapy may cause the Varroa destructor mite to become sick, not replicate and/or die due to lysis or death of bacteria within the Varroa destructor mite.

### Example 7: Exemplary Alternatives

Various alternative steps and modified approaches to identifying, characterizing, isolating, purifying, and preparing bacteriophages for inclusion in a composition (or method) for use in treating Varroa destructor infestation in a beehive having Varroa destructor infestation will be apparent to those skilled in the art. In general, such methods can include one or more of the following: (1) collecting environment sample(s); (2) setting up enrichment culture; (3) isolating phage from the enrichment culture; (4) purifying the phage; (5) phage titer test to high concentration; (6) characterizing the phage (e.g., using electron microscope and/or genomic DNA isolation and sequencing); (7) optionally performing a restriction enzyme assay/analysis; (8) performing a lytic activity assay; (9) optionally preparing a phage frozen stock; (10) optionally combining two or more strains of selected/suitable bacteriophage strains; (11) testing safety and efficacy of the bacteriophage (or mixture of bacteriophages); and so forth.

Illustratively, the method can include collecting a (biological) sample containing (naturally-occurring) bacteriophage, such as an environmental sample from, for example, soil, plant (material), sewage, sewage water, or other environmental source. An enrichment culture can then be established for enriching suitable bacteriophage. The enrichment culture can include, for example, 25 mL LB broth, 1 mL target bacterium (from (inside) Varroa destructor), and 1 mL of the environment sample. The inoculated enrichment culture is then incubated (e.g., at 35° C. for 2 days with aeration). Following incubation, the liquid can be transferred from the flask into a cylindrical or conical tube for centrifugation (e.g., at 8000 RPM for 20 minutes). The supernatant can then be filtered (e.g., using a 0.45 μm filter) into another sterile conical tube and optionally refrigerated.

Various (enriched) phage can then be isolated from the enrichment culture. For example, the filtered enrichment culture can be mixed and serially diluted (e.g., by factors of 10) to a final concentration of 1×10′ PFU/mL. An overnight culture of the target bacterium can then be inoculated into each tubes of the dilution series (e.g., using 500 μL of the bacterial culture). The inoculated tubes are then incubated at 35° C. for 40 minutes. Following incubation, each sample is mixed with 5 mL of melted top agar and plated (e.g., onto petri dishes). The plated samples are incubated for 24 h or until plaque formation is visible.

The target phages or phage strains (or lines) are purified by picking a single plaque with a sterile needle and transferring to sterile media (e.g., LB broth). The inoculated media is mixed, incubated, and phages picked from a resulting plaque are filtered as before prior to serial dilution. An overnight culture of the target bacterium can then be inoculated into each tubes of the dilution series (e.g., using 500 μL of the bacterial culture). The inoculated tubes are then incubated at 35° C. for 40 minutes. Following incubation, each sample is mixed with 5 mL of melted top agar and plated (e.g., onto petri dishes). The plated samples are incubated for 24 h or until plaque formation is visible. This phage purification process may be repeated two or more times, as necessary (e.g., to achieve a suitable, threshold level or optimal level of confidence regarding purity of a (single) phage strain or line).

Following the purification step, the phage titer is determined. This can allow isolation of phage to an adequate high concentration in preparation for further analysis. The phage titer assay can be conducted, for example, by mixing 20 mL LB broth, 0.5 mL of an overnight culture of the target bacterium, and plaque picking from the last phage purification round that had been suspended in 100 uL LB broth. The flask is then incubated at 35° C. for 2 days with medium shaking. Following this incubation period, the sample is centrifuged (e.g., 8000 rpm for 10-15 minutes) and supernatant filtered (e.g., through a 0.45 μm filter). The filtered supernatant can then be used, as above, to generate plaques for determining the concentration of phage within the filtered lysate.

Preferably, the final concentration of the phage lysate is greater than or equal to 1×10³ PFU/mL, more preferably greater than or equal to 1×10⁴ PFU/mL, still more preferably greater than or equal to 1×10⁵ PFU/mL, still more preferably greater than or equal to 1×10⁶ PFU/mL, still more preferably greater than or equal to 1×10⁷ PFU/mL, still more preferably greater than or equal to 1×10⁸ PFU/mL, still more preferably greater than or equal to 1×10⁹ PFU/mL, still more preferably greater than or equal to 1×10¹⁰ PFU/mL, still more preferably greater than or equal to 1×10¹¹ PFU/mL, still more preferably greater than or equal to 1×10¹² PFU/mL.

The phage can then be characterized. Illustratively, phage characterization can include isolating the phage DNA using methods and phage DNA isolation kits, as known in the art. The isolated phage DNA can be sequenced using any method or suitable technology known in the art. The sequenced phage DNA can be used to confirm the lack of any bacterial toxin and/or virulence factor and/or integrase gene, and to compare with other phage DNA having a similar tropism for a relative genetic similarity. Genetically- and/or genomically-suitable phage can be selected for further characterization, analysis, and/or processing.

Phage can be further characterized using electron microscopy (data). Illustratively, 10 μL of phage lysate can be combined with 10 μL of tungsten heavy metal solution and placed on an electron microscopy grid and viewed via electron microscopy, as known in the art. The electron microscopy data can be used to determine phage morphology and structural classification. Morphologically- and/or structurally-suitable phage can be selected for further characterization, analysis, and/or processing.

Exemplary method(s) for determining lytic activity and tropism for identified and/or selected bacteriophages can also be implemented. To identify lytic phages, a target bacterium from (inside) the Varroa destructor mites can be diluted from an overnight culture to a concentration of 1×10⁶ colony-forming units per milliliter (CFU/mL) and inoculated with phage tittered to a concentration of 1×10⁸ PFU/mL, for example, giving a multiplicity of infection of 100. One milliliter of sample can be removed from the flask, serial diluted, spread over LB-agar plates, and incubated overnight. The number of surviving bacteria can be determined by colony count the next day. An additional 1 mL of each sample can be removed from respective cultures every 2 hours during the first 12 hours after inoculation then once more at the 24^{th} hour after inoculation to detect whether the phage was lytic and whether bacteria develop resistance within the first 24 hours.

The (cellular) tropism, or target specificity or infectivity, of each phage can be tested by measuring its ability to lyse a range of bacteria, from closely to distantly related bacterial strains. Illustratively, host range testing of bacteriophages that are initially isolated based on their ability to lyse bacteria from (inside) the Varroa destructor mites can be tested against two other species of the same bacterial genus and/or other strains of the same bacterial genus species. Furthermore, host range testing of bacteriophages against more distantly related genera or bacteria genus can be tested.

Spot test(s) can be performed by dropping 10 μL of the respective phage solution containing 1×10⁹ PFU/mL onto a lawn of specified-target bacterium and incubating overnight at 37° C. Results are illustrated by a positive indication corresponding to clearing of bacteria in the location where the phages were dropped or “spotted” on the plate. The clearance indicates lysis of the target bacterium and therefore tropism for the same. For example, different phages display tropism for different bacterial strains, while maintaining tropism for many (or all) of the originally-tested species or strains.

The lytic activity of the phages toward each vulnerable strain of bacteria can be further quantified by mixing, for example, 100 μL of 1×10⁹ PFU/mL phage with 500 μL of 1×10⁹ CFU/mL bacteria and incubating overnight at 37° C. with shaking. The overnight cultures can be serially diluted, plated, and plaques were enumerated on the incubated plates to assess each phage's ability to replicate in the host bacteria. Different phages display tropisms specific for different strains of target bacteria from (inside) the Varroa destructor mite and/or may be capable of replicating within and lysing different strains.

In some embodiments, in order for identified phages to be considered for inclusion in the disclosed compositions, it can, should, or must first be demonstrated that each phage can survive conditions in or internal to the Varroa mite. Accordingly, a calculated concentration of selected phage or phage cocktails can be administered to Varroa mites, followed by mite collection from which the concentration of phage can be measured. Phages shown by these tests to survive and replicate in (or inside) the Varroa mite may be considered or selected for subsequent development of a compositions.

Further in vivo proof-of-principle testing can be performed to determine whether phage can (1) cause bacteriophage-induced death or lysis of bacteria present in (or inside) Varroa destructor associated with the beehive and/or the bees, and particularly Bacillus sp. (e.g., Bacillus paralicheniformis), Hafnia sp. (e.g., Hafnia paralvei), and/or Escherichia sp. (e.g., Escherichia coil) in or inside Varroa destructor, (2) cause death of Varroa destructor associated with the beehive and/or the bees, and/or (3) inhibit reproduction, maturation, and/or growth in Varroa destructor or a population of Varroa destructor associated with the beehive and/or the bees.

### Example 8: Genomic Sequences of Illustrative Bacteriophage

The Sequence Listing accompanying the present disclosure and submitted herewith forms a part of the present disclosure and is incorporated herein by specific reference.

### CONCLUSION

It will be appreciated that systems, devices, products, kits, methods, and/or processes, according to certain embodiments of the present disclosure may include, incorporate, or otherwise comprise properties, features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Likewise, any steps recited in any method or process described herein and/or recited in the claims can be executed in any suitable order and are not necessarily limited to the order described and/or recited, unless otherwise stated (explicitly or implicitly). Such steps can, however, also be performed in a specific order or any suitable order in certain embodiments of the present disclosure.

The present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. While certain embodiments and details have been included herein and in the attached disclosure for purposes of illustrating embodiments of the present disclosure, it will be apparent to those skilled in the art that various changes in the compositions and kits disclosed herein may be made without departing from the scope of the disclosure or of the invention, which is defined in the appended claims. All changes which come within the meaning and range of equivalency of the claims are to be embraced within their scope.

1. A composition for use in treating Varroa destructor infestation in a beehive having Varroa destructor infestation, the composition comprising:
a carrier or excipient;
one or more bacteriophage having a genome with a nucleic acid sequence selected from the group consisting of SEQ ID NO. 1 through SEQ ID NO. 13, or having a genome with at least 70% sequence identity to one of SEQ ID NO. 1 through SEQ ID NO. 13, and wherein each of the one or more bacteriophage has specificity or cellular tropism for one or more strain of Bacillus sp., one or more strain of Hafnia sp., or one or more strain of Escherichia sp., present in, internal to, and/or associated with Varroa destructor that is associated with the beehive or with bees associated with the beehive.

2. The composition of claim 1, wherein the composition comprises two or more having respective genomes with respective nucleic acid sequences selected from the group consisting of SEQ ID NO. 1 through SEQ ID NO. 13, or having a genome with at least 70% sequence identity to one of SEQ ID NO. 1 through SEQ ID NO. 13, and wherein each of the two or more has specificity or cellular tropism for the one or more strain of Bacillus sp., the one or more strain of Hafnia sp., or the one or more strain of Escherichia sp., present in, internal to, and/or associated with the Varroa destructor associated with the beehive and/or the bees.

3. The composition of claim 2, wherein the respective bacteriophage each have or comprise, compared to other bacteriophage in the composition, (i) different host cell receptor specificity for attachment and/or (ii) less than or equal to 99% genomic sequence identity.

4. The composition of claim 1, wherein each of the one or more bacteriophage has a genome with a nucleic acid sequence having at least 75% sequence identity to one of SEQ ID NO. 1 through SEQ ID NO. 13.

5. The composition of claim 1, wherein each of the one or more bacteriophage is present in the composition at greater than or equal to about 1×10⁴ plaque forming units (PFU) per milliliter (PFU/mL) of the composition or greater than or equal to about 1×10⁴ PFU per milligram (PFU/mg) of the composition.

6. The composition of claim 1, wherein:
each of the one or more bacteriophage is lytic and/or has lytic activity against the one or more strain of Bacillus sp., the one or more strain of Hafnia sp., and the one or more strain of Escherichia sp., present in, internal to, and/or associated with Varroa destructor associated with the beehive and/or the bees; and/or
each of the one or more bacteriophage is not lysogenic and/or does not have lysogenic activity against the one or more strain of Bacillus sp., the one or more strain of Hafnia sp., and the one or more strain of Escherichia sp., present in, internal to, and/or associated with Varroa destructor associated with the beehive and/or the bees.

7. The composition of claim 1, wherein the carrier or excipient comprises a buffering solution.

8. The composition of claim 1, wherein applying or administering the composition to a beehive having Varroa destructor infestation, or to bees associated with the beehive, is effective to:
cause bacteriophage-induced death or lysis of one or more strain of Bacillus sp. and/or one or more strain of Hafnia sp., and/or one or more strain of Escherichia sp., present in, internal to, and/or associated with Varroa destructor associated with the beehive and/or the bees;
cause death of Varroa destructor associated with the beehive and/or the bees; and/or
inhibit reproduction, maturation, and/or growth in Varroa destructor or a population of Varroa destructor associated with the beehive and/or the bees.

9. A method of treating Varroa destructor infestation in a beehive, the method comprising applying or administering to a beehive having Varroa destructor infestation, or to bees associated with the beehive, the composition of claim 1.

10. The method of claim 9, wherein the step of applying or administering the composition to the beehive, or to the bees associated with the beehive, is effective to:
cause bacteriophage-induced death or lysis of one or more strain of Bacillus sp. and/or one or more strain of Hafnia sp., and/or one or more strain of Escherichia sp.) present in, internal to, and/or associated with Varroa destructor associated with the beehive and/or the bees; and/or
cause death of Varroa destructor associated with the beehive and/or the bees; and/or
inhibit reproduction, maturation, and/or growth in Varroa destructor or a population of Varroa destructor associated with the beehive and/or the bees.

11. A composition for use in treating Varroa destructor infestation in a beehive having Varroa destructor infestation, comprising:
a carrier or excipient; and
a bacteriophage cocktail comprising two or more sets of bacteriophage, selected from the group consisting of:
a first set of bacteriophage comprising one or more bacteriophage each having a genome with a nucleic acid sequence selected from the group consisting of SEQ ID NO. 1 through SEQ ID NO. 5, or having at least 70% sequence identity to one of SEQ ID NO. 1 through SEQ ID NO. 5, wherein each bacteriophage in the first set has specificity or cellular tropism for at least one strain of Bacillus sp.;
a second set of bacteriophage comprising one or more bacteriophage each having a genome with a nucleic acid sequence selected from the group consisting of SEQ ID NO. 6 through SEQ ID NO. 9, or having at least 70% sequence identity to one of SEQ ID NO. 6 through SEQ ID NO. 9, wherein each bacteriophage in the second set has specificity or cellular tropism for at least one strain of Hafnia sp.; and
a third set of bacteriophage comprising one or more bacteriophage each having a genome with a nucleic acid sequence selected from the group consisting of SEQ ID NO. 10 through SEQ ID NO. 13, or having at least 70% sequence identity to one of SEQ ID NO. 10 through SEQ ID NO. 13, wherein each bacteriophage in the third set has specificity or cellular tropism for at least one strain of Escherichia sp.

12. The composition of claim 11, wherein:
each of the one or more bacteriophage in the first set of bacteriophage has a genome with a nucleic acid sequence having at least 75% sequence identity to one of SEQ ID NO. 1 through SEQ ID NO. 5;
each of the one or more bacteriophage in the second set of bacteriophage has a genome with a nucleic acid sequence having at least 75% sequence identity to one of SEQ ID NO. 6 through SEQ ID NO. 9; and/or
each of the one or more bacteriophage in the third set of bacteriophage has a genome with a nucleic acid sequence having at least 75% sequence identity to one of SEQ ID NO. 10 through SEQ ID NO. 13.

13. The composition of claim 11, wherein the respective bacteriophage in each of the first set of bacteriophage, the second set of bacteriophage, and the third set of bacteriophage are each present in the composition at greater than or equal to about 1×10⁴ plaque forming units (PFU) per milliliter (PFU/mL) of the composition or greater than or equal to about 1×10⁴ PFU per milligram (PFU/mg) of the composition.

14. The composition of claim 11, wherein:
the respective bacteriophage in each of the first set of bacteriophage, the second set of bacteriophage, and the third set of bacteriophage are each lytic and/or have lytic activity against the one or more strain of Bacillus sp., the one or more strain of Hafnia sp., and the one or more strain of Escherichia sp., respectively; and/or
the respective bacteriophage in each of the first set of bacteriophage, the second set of bacteriophage, and the third set of bacteriophage are each lysogenic and/or do not have lysogenic activity against the one or more strain of Bacillus sp., the one or more strain of Hafnia sp., and the one or more strain of Escherichia sp., respectively.

15. The composition of claim 11, wherein the bacteriophage cocktail comprises the first set of bacteriophage, the second set of bacteriophage, and the third set of bacteriophage.

16. The composition of claim 11, wherein:
the first set of bacteriophage comprises two or more bacteriophage each having a genome with a nucleic acid sequence selected from the group consisting of SEQ ID NO. 1 through SEQ ID NO. 5, or having at least 70% sequence identity to one of SEQ ID NO. 1 through SEQ ID NO. 5, wherein each bacteriophage in the first set has specificity or cellular tropism for at least one strain of Bacillus sp.;
the second set of bacteriophage comprises two or more bacteriophage, each having a genome with a nucleic acid sequence selected from the group consisting of SEQ ID NO. 6 through SEQ ID NO. 9, or having at least 70% sequence identity to one of SEQ ID NO. 6 through SEQ ID NO. 9, wherein each bacteriophage in the second set has specificity or cellular tropism for at least one strain of Hafnia sp., and/or
the third set of bacteriophage comprises two or more bacteriophage each having a genome with a nucleic acid sequence selected from the group consisting of SEQ ID NO. 10 through SEQ ID NO. 13, or having at least 70% sequence identity to one of SEQ ID NO. 10 through SEQ ID NO. 13, wherein each bacteriophage in the third set has specificity or cellular tropism for at least one strain of Escherichia sp.

17. The composition of claim 16, wherein:
each of the two or more bacteriophage in the first set of bacteriophage has a genome with a nucleic acid sequence having at least 75% sequence identity to one of SEQ ID NO. 1 through SEQ ID NO. 5;
each of the two or more bacteriophage in the second set of bacteriophage has a genome with a nucleic acid sequence having at least 75% sequence identity to one of SEQ ID NO. 6 through SEQ ID NO. 9; and/or
each of the two or more bacteriophage in the third set of bacteriophage has a genome with a nucleic acid sequence having at least 75% sequence identity to one of SEQ ID NO. 10 through SEQ ID NO. 13.

18. The composition of claim 16, wherein:
the respective bacteriophage of the first set of bacteriophage each have or comprise, compared to other bacteriophage in the first set (i) different host cell receptor specificity for attachment and/or (ii) less than or equal to 99% genomic sequence identity;
the respective bacteriophage of the second set of bacteriophage each have or comprise, compared to other bacteriophage in the second set (i) different host cell receptor specificity for attachment and/or (ii) less than or equal to 99% genomic sequence identity; and
the respective bacteriophage of the third set of bacteriophage each have or comprise, compared to other bacteriophage in the third set (i) different host cell receptor specificity for attachment and/or (ii) less than or equal to 99% genomic sequence identity.

19. The composition of claim 11, wherein the carrier or excipient comprises a buffering solution.

20. The composition of claim 11, wherein applying or administering the composition to a beehive having Varroa destructor infestation, or to bees associated with the beehive, is effective to:
cause bacteriophage-induced death or lysis of one or more strain of Bacillus sp., one or more strain of Hafnia sp., and one or more strain of Escherichia sp., present in, internal to, and/or associated with Varroa destructor associated with the beehive and/or the bees; and/or
cause death of Varroa destructor associated with the beehive and/or the bees; and/or
inhibit reproduction, maturation, and/or growth in Varroa destructor or a population of Varroa destructor associated with the beehive and/or the bees.

21. A method of treating Varroa destructor infestation in a beehive, the method comprising applying or administering to a beehive having Varroa destructor infestation, or to bees associated with the beehive, the composition of claim 11.

22. The method of claim 21, wherein the step of applying or administering the composition to the beehive, or to the bees associated with the beehive, is effective to:
cause bacteriophage-induced death or lysis of two or more strains of bacteria present in, internal to, and/or associated with Varroa destructor associated with the beehive and/or the bees, the two or more strains selected from the group consisting of (i) one or more strain of Bacillus sp., (ii) one or more strain of Hafnia sp., and (iii) one or more strain of Escherichia sp.,
cause death of Varroa destructor associated with the beehive and/or the bees; and/or
inhibit reproduction, maturation, and/or growth in Varroa destructor or a population of Varroa destructor associated with the beehive and/or the bees.

23. A method of treating Varroa destructor infestation in a beehive, the method comprising applying or administering to a beehive having Varroa destructor infestation, or to bees associated with the beehive, a composition comprising:
a carrier or excipient;
one or more bacteriophage having specificity or cellular tropism for one or more strain of Bacillus sp., one or more strain of Hafnia sp., or one or more strain of Escherichia sp., present in, internal to, and/or associated with Varroa destructor associated with the beehive and/or the bees.

24. The method of claim 23, wherein the composition comprises two or more bacteriophage each having specificity or cellular tropism for one or more strain of bacteria selected from the group consisting of Bacillus sp., Hafnia sp., preferably and Escherichia sp., present in, internal to, and/or associated with Varroa destructor associated with the beehive and/or the bees.

25. The method of claim 23, wherein the composition comprises:
a first bacteriophage having specificity or cellular tropism for Bacillus sp.;
a second bacteriophage having specificity or cellular tropism for Hafnia sp.;
a third bacteriophage having specificity or cellular tropism for Escherichia sp.;
a first bacteriophage having specificity or cellular tropism for Bacillus sp. and a second bacteriophage having specificity or cellular tropism for Hafnia sp.;
a first bacteriophage having specificity or cellular tropism for Bacillus sp. and a third bacteriophage having specificity or cellular tropism for Escherichia sp.;
a second bacteriophage having specificity or cellular tropism for Hafnia sp., and a third bacteriophage having specificity or cellular tropism for Escherichia sp.; or
a first bacteriophage having specificity or cellular tropism for Bacillus sp. and a second bacteriophage having specificity or cellular tropism for Hafnia sp. and a third bacteriophage having specificity or cellular tropism for Escherichia sp.

26. The method of claim 23, wherein the composition comprises:
a first set of bacteriophage comprising two or more bacteriophage, preferably three or more bacteriophage, more preferably four or more bacteriophage, each having specificity or cellular tropism for Bacillus sp.;
a second set of bacteriophage comprising two or more bacteriophage, each having specificity or cellular tropism for Hafnia sp.; and/or
a third set of bacteriophage comprising two or more bacteriophage, each having specificity or cellular tropism for Escherichia sp.

27. A process of preparing a composition for use in treating Varroa destructor infestation in a beehive having Varroa destructor infestation, the process comprising the steps of:
obtaining one or more strains of bacteria from Varroa destructor mites, the one or more strains of bacteria selected from the group consisting of at least one strain of Bacillus sp., at least one strain of Hafnia sp., and at least one strain of Escherichia sp., wherein obtaining the one or more strains of bacteria comprises (i) isolating the Varroa destructor mites from the beehive, (ii) optionally sterilizing (the surface or exterior of) the Varroa destructor mites, by exposure to UV light, and/or (iii) disrupting or homogenizing the optionally sterilized Varroa destructor mites, by sterile mortar and pestle or bead-beating;
contacting the bacteria with a biological sample containing bacteriophage, the biological sample containing naturally-occurring bacteriophage, the biological sample comprising soil, plant material, sewage, or sewage water, and incubating the one or more strains of bacteria with the bacteriophage from the biological sample in an enrichment culture;
isolating enriched bacteriophage from the enrichment culture and purifying the isolated enriched bacteriophage to obtain one or more enriched bacteriophage strains, wherein the enriched bacteriophage are more numerous in the enrichment culture than in the biological sample;
characterizing the one or more enriched bacteriophage strains by:
sequencing respective genomes of each of the one or more enriched bacteriophage strains and selecting bacteriophage strains having a genome devoid of toxin genes, virulence factor genes, and/or integrase genes, and optionally determining a level of genomic redundancy between the one or more enriched bacteriophage strains;
measuring lytic activity of the one or more enriched bacteriophage strains and selecting bacteriophage strains that are lytic and/or not lysogenic; and/or
determining specificity or cellular tropism of the one or more enriched bacteriophage strains and selecting bacteriophage strains with specificity or cellular tropism for at least one of the one or more strains of bacteria from Varroa destructor mites, the at least one strain selected from the group consisting of a strain of Bacillus sp., a strain of Hafnia sp., and a strain of Escherichia sp.; and
combining one or more of the selected bacteriophage strains with a carrier or excipient.
